(19) United States
(12) Patent Application Publication
(10) Pub. No.: US 2024/0387081 A1
(43) Pub. Date: Nov. 21, 2024

(54) MAGNETIC STRUCTURE WITH SPIKE STRUCTURE AND METHOD FOR PREPARING THE SAME

(71) Applicant: Korea University Research and Business Foundation, Seoul (KR)

(72) Inventors: Heemin KANG, Seoul (KR); Sunhong Min, Suwon-si (KR); Hyunshik Hong, Seoul (KR); Seong Yeol Kim, Seoul (KR); Kanghyeon Kim, Gwangju (KR); Chowon Kim, Gimhae-si (KR)

(73) Assignee: Korea University Research and Business Foundation, Seoul (KR)

(21) Appl. No.: 18/406,988

(22) Filed: Jan. 8, 2024

(30) Foreign Application Priority Data
May 15, 2023 (KR) 10-2023-0062375

(51) Int. Cl. H01F 1/00

(52) U.S. Cl. CPC H01F 1/0045

(57) ABSTRACT

Disclosed is a magnetic structure having a spike structure, the magnetic structure comprising: a core including at least one magnetic nanoparticle; a buffer disposed on an outer surface of the core; a shell disposed on an outer surface of the buffer, and at least one spike structure protruding outwardly from the shell, wherein the spike structure is controlled to have various shapes.

### CROSS-REFERENCE TO RELATED APPLICATION

This application claims priority from Korean Patent Application No. 10-2023-0062375 filed on May 15, 2023 in the Korean Intellectual Property Office, and all the benefits accruing therefrom under 35 U.S.C. 119, the contents of which in its entirety are herein incorporated by reference.

### BACKGROUND

### Field

The present disclosure relates to a magnetic structure with a spike structure, and a method for preparing the same. More specifically, the present disclosure relates to a magnetic structure having a spike structure in which the magnetic structure may be applied for various purposes by controlling the spike structure in various ways, and a method for preparing the same.

### Description of Related Art

Nanotechnology refers to technology that deals with nanometer-sized materials, and is a technology that studies new phenomena and characteristics that appear at nanometer sizes and creates materials that may be applied to real life based on the study result. Currently, nanotechnology is being applied in various fields around the world. In this regard, research on nano biotechnology in which the Nanotechnology is combined with biotechnology is actively underway.

Research on magnetic nanoparticles is rapidly increasing as the magnetic nanoparticles are applied to diagnostic biosensors, drug delivery materials, contrast agents, cancer cell death inducing materials, and heat therapy materials. Furthermore, these magnetic nanoparticles provide a safe medical technology that may reduce side effects and simultaneously meet the requirements in the medical technology, such as rapid diagnosis and treatment result acquisition, high accuracy, and high cure rate, and thus, recently, are receiving attention in the bio and medical fields. However, in order for the magnetic nanoparticles to be applied to the bio and medical fields, the magnetic nanoparticles should meet several requirements.

First, in order that the magnetic nanoparticles generate uniform magnetic field, and exhibit more accurate and uniform properties, the magnetic nanoparticles should not aggregate with each other, and should have the particle sizes that may have superparamagnetism and a spherical particle shape. Further, in order for the magnetic nanoparticle to respond to even minute changes in the externally applied or induced magnetic field, the magnetic nanoparticle should have an improved saturation magnetization value and high magnetic susceptibility, and should have high chemical stability. Furthermore, the magnetic nanoparticle should be designed to have affinity to living cells or to maintain magnetic properties when the magnetic nanoparticle surface is coated with a biocompatible material. In other words, both the magnetism and biocompatibility of the nanoparticles should be satisfied and, thus, the nanoparticle may ultimately be applied to the bio and medical fields.

However, currently, due to technical limitations, the magnetic nanoparticles are freely applied directly to the bio and medical fields.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide a magnetic structure with a spike structure that has excellent magnetic properties, high crystallinity, and in which the spike structure can be controlled, and a method for preparing the same.

Furthermore, another purpose of the present disclosure is to provide a magnetic structure with a spike structure in which a moving speed and a moving distance thereof can be controlled in a remote manner by applying an external magnetic field thereto, and an external force can be applied to a specific area thereof via the spike structure, and a method for preparing the same.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

According to one aspect of the present disclosure, embodiments of the present disclosure include a magnetic structure having a spike structure and a method for preparing the same.

A first aspect of the present disclosure provides a magnetic structure having a spike structure, the magnetic structure comprising: a core including at least one magnetic nanoparticle; a buffer disposed on an outer surface of the core; a shell disposed on an outer surface of the buffer; and at least one spike structure protruding outwardly from the shell, wherein the spike structure is controlled to have various shapes.

In one implementation of the magnetic structure, the spike structure further includes a plurality of branches protruding from an outer surface of the spike structure, wherein each of the branches extends from at least a portion of a (111) crystal plane of the outer surface of the spike structure.

In one implementation of the magnetic structure, the spike structure or the branch includes a nanotwin structure.

In one implementation of the magnetic structure, an average diameter of a bottom surface of the spike structure is a first length, a height of the spike structure is a second length, and a ratio of the second length to the first length is in a range of 3 to 5, wherein a cross-sectional shape of the bottom surface of the spike structure is at least one of circular, triangular, square and polygonal shapes.

In one implementation of the magnetic structure, the first length is in a range of 10 nm to 35 nm, and the second length is in a range of 30 nm to 80 nm.

In one implementation of the magnetic structure, an average diameter of the magnetic nanoparticle is in a range of 5 nm to 15 nm, wherein the core has paramagnetic property and an average diameter of the core is in a range of 10 nm to 700 nm, wherein an average diameter of the magnetic structure is in a range of 50 nm to 800 nm.

In one implementation of the magnetic structure, the core includes at least one of Fe₃O₄, Fe₂O₃, CoFe₂O₄, MnFe₂O₄, CoPt, and FePt, wherein the buffer includes at least one of m functional-group introduced silica (SiO₂), amine-silica, and thiol-silica, wherein each of the shell and the spike structure includes gold (Au), silver (Au), or gold-silver (Ag—Au) alloy.

In one implementation of the magnetic structure, the buffer has an average thickness in a range of 10 nm to 100 nm, wherein the shell has an average thickness in a range of 10 nm to 20 nm.

In one implementation of the magnetic structure, the magnetic structure has paramagnetic property, wherein movement of the magnetic structure is controlled under application of an external magnetic field thereto, wherein as an average diameter of the core increases, a movement speed of the magnetic structure increases, wherein a stab movement of a vertex of the spike structure of stabbing a surrounding object is controlled based on the movement speed of the magnetic structure.

In one implementation of the magnetic structure, wherein the magnetic structure includes a plurality of magnetic structures connected to each other via a first bond or a second bond to form an aggregate.

In one implementation of the magnetic structure, the first bond includes a magnetic force caused by application of an external magnetic field, wherein the second bond includes π-π interaction due to the magnetic structure, wherein the aggregate of the plurality of magnetic structures has at least one of: a structure in which the plurality of magnetic structures are arranged one-dimensionally and connected to each other via the first bond; a structure in which the plurality of magnetic structures are arranged in a two-dimensional manner and connected to each other via the first bond or the second bond; and a structure in which the plurality of magnetic structures are arranged in a three-dimensional manner and connected to each other via the first bond or the second bond.

In one implementation of the magnetic structure, the shell includes at least one of a (111) crystal plane, a (100) crystal plane, and a (110) crystal plane, wherein the spike structure has a bottom surface in contact with the shell, and the bottom surface extends from at least a portion of the (111) crystal plane.

A second aspect of the present disclosure provides a method for preparing the magnetic structure having the spike structure as described above, the method comprising preparing the core including the at least one magnetic nanoparticle; coating silica on an outer surface of the core and then introducing a functional-group onto the silica to form the buffer; forming seeds on an outer surface of the buffer using a seed precursor solution, and forming the shell on the outer surface of the buffer using a shell precursor solution in the seed-mediated growth manner; and forming at least one spike structure protruding from the shell using a spike precursor solution.

In one implementation of the method, the spike structure has a bottom surface in contact with the shell and has a cone shape extending in one direction and having a vertex, wherein an average diameter of the bottom surface of the spike structure is a first length, and a height of the spike structure is a second length, wherein the shell includes at least one of a (111) crystal plane, a (100) crystal plane, and a (110) crystal plane, wherein the bottom surface extends from at least a portion of the (111) crystal plane.

In one implementation of the method, preparing the core includes: adding and dispersing one or more magnetic nanoparticles to and in a first organic solvent; adding and mixing a dispersant solution to and with the first organic solvent in which the magnetic nanoparticles have been dispersed, thereby preparing an oil-in-water microemulsion; removing the first organic solvent from the oil-in-water microemulsion; and adding and stirring a polymer solution to the oil-in-water microemulsion, thereby preparing the core as a cluster of a plurality of magnetic nanoparticles in which the plurality of magnetic nanoparticles with an average diameter of 50 nm to 700 nm are aggregated with each other.

In one implementation of the method, the first organic solvent may include at least one of chloroform, hexane, benzene, and toluene, wherein the dispersant solution may be prepared by adding at least one of dodecyltrimethylammonium bromide (DTAB), cetyltrimethylammonium bromide (CTAB), and cetyltrimethylammonium chloride (CTAC) to deionized water (DI water), wherein the polymer solution may be prepared by dissolving a polymer in the ethylene glycol-based compound as a solvent, wherein the ethylene glycol-based compound may include at least one of monoethylene glycol dimethyl ether, diethylene glycol dimethyl ether, triethylene glycol dimethyl ether, and tetraethylene glycol dimethyl ether, wherein the polymer may include at least one of polyvinylpyrrolidone (PVP) and polyacrylic acid (PAA).

In one implementation of the method, forming the buffer includes: dispersing the cores in the second organic solvent; adding and mixing ammonia solution or sodium hydroxide aqueous solution to and with the second organic solvent containing the cored dispersed therein, and adding and mixing silica precursor thereto and therewith, thereby coating an outer surface of the core with silica; and dispersing the silica-coated cores in an alcohol solvent, and adding a functional-group solution thereto and therewith, thereby introducing a functional-group onto the silica.

In one implementation of the method, the second organic solvent may include at least one of ethanol, deionized water, and acetone, wherein the ammonia solution may be prepared by mixing an ammonia compound with deionized water, wherein the silica precursor may include tetraethyl orthosilicate (TEOS), wherein the functional-group solution may include at least one of 3-aminopropyl triethoxysilane (APTES), [3-(2-Aminoethylamino)propyl] trimethoxysilane, and (3-aminopropyl) trimethoxysilane, wherein the alcohol solvent may include at least one of ethanol, deionized water, methanol, and acetone, wherein the ammonia compound may include at least one of ammonium sulfate, ammonium chloride, ammonium nitrate, and ammonium phosphate.

In one implementation of the method, the seed precursor solution includes a first basic solution, a first metal aqueous solution, and a seed reductant, wherein the shell precursor solution includes a second basic solution and a second metal aqueous solution, wherein forming the shell includes: dispersing the cores having the buffer formed thereon in a first dispersion solvent to prepare a first mixture; adding and stirring the first mixture to the seed precursor solution to form seeds on the buffer; washing the cores having the buffer and the seeds formed thereon at least once and then dispersing the washed cores in a second dispersion solvent, thereby preparing a second mixture; adding and stirring the second mixture to the shell precursor solution, and then adding a first additive and a second additive thereto, followed by stirring for 0.5 hour to 10 hours; and after completion of the stirring, isolating a solid material and washing the isolated solid material at least once.

In one implementation of the method, the first dispersion solvent may include at least one of deionized water (DI water), ethanol, methanol, and acetone, wherein the first basic solution may include at least one of sodium hydroxide (NaOH) aqueous solution, potassium hydroxide (KOH) aqueous solution, magnesium hydroxide (Mg(OH)₂) aqueous solution, and calcium hydroxide (Ca(OH)₂) aqueous solution, wherein the seed reductant may include at least one of tetrakis (hydroxymethyl) phosphonium chloride (THPC), L-Ascorbic acid (LAA), citric acid, sodium borohydride, and hydroquinone (HQ), wherein each of the first and second metal aqueous solutions may include at least one of HAuCl₄, HAuBr₄ AuCl, and AuBr, wherein the second basic solution may include at least one of K₂CO₃, Na₂CO₃, NaHCO₃, KHCO₃, (NH₄)₂CO₃, and NH₄HCO₃, wherein the first additive may include bis(p-sulfonatophenyl)phenylphosphine dihydrate dipotassium salt (BSPP), wherein the second additive may include at least one of paraformaldehyde (PFA), L-Ascorbic acid (LAA), citric acid, sodium borohydride, and hydroquinone (HQ).

In one implementation of the method, the spike precursor solution includes a surfactant solution, a third metal aqueous solution, a silver ion compound, a spike reductant, and a functional-group introducing agent, wherein forming the spike structure includes: adding and mixing the cores having the buffer and the shell formed thereon, the third metal aqueous solution, and the silver ion compound to a reactor containing therein the surfactant solution; and adding the spike reductant at a first concentration to the reactor, and performing a reaction at least once for a first time, and then adding the functional-group introducing agent thereto, wherein a concentration of the silver ion compound is in a range of 1 mM to 20 mM, wherein a concentration of the surfactant is in a range of 200 mM to 500 mM, wherein the first concentration of the spike reductant is in a range of 1 mM to 20 mM, wherein the first time is in a range of 10 minutes to 60 minutes.

In one implementation of the method, a ratio (Ag⁺/Au³⁺) of a content of silver ions contained in the silver ion compound to a content of metal ions contained in the third metal aqueous solution is in a range of 1 to 4, wherein as the ratio (Ag⁺/Au³⁺) increases, the first length decreases, whereas when the ratio (Ag⁺/Au³⁺) decreases, the first length increases, wherein as the concentration of the surfactant solution increases, the first length decreases, whereas when the concentration of the surfactant decreases, the first length increases, wherein a number of additions of the spike reductant is in a range of 1 to 7 times, wherein as the number of additions of the spike reductant increases, the second length increases, whereas as the number of additions of the spike reductant decreases, the second length decreases.

In one implementation of the method, the concentration of the surfactant solution is in a range of 300 mM to 500 mM and the concentration of the spike reductant is in a range of 15 mM to 20 mM, wherein as a number of additions of the spike reductant increases, the spike structure has a twin structure along the (111) crystal plane, and the second length thereof increases.

In one implementation of the method, as the concentration of the surfactant solution is lower, the spike structure grows along the (100) crystal plane and the (110) crystal plane, and the first length is in a range of 10 nm to 35 nm, and a twin structure is absent in the spike structure.

In one implementation of the method, the concentration of the silver ion compound increases, a density of the spike structures and the second length of the spike structure increase, wherein when the concentration of the silver ion compound is 5 mM and a volume thereof is in a range of 20 [symbol] to 200 [symbol] , the first length increases as a concentration of the third metal aqueous solution increases.

In one implementation of the method, the surfactant solution may include at least one of 2-[4-(2,4,4-trimethylpentan-2-yl) phenoxy] ethanol, triton-X100 aqueous solution, dodecyltrimethylammonium bromide (DTAB), cetyltrimethylammonium bromide (CTAB), cetyltrimethylammonium chloride (CTAC), polyoxyethylene nonyl phenyl ether, octylphenoxy poly (ethyleneoxy) ethanol, and polyethylene glycol nonyl phenyl ether, wherein the third metal aqueous solution may include at least one of HAuCl₄, HAuBr₄, AuCl, and AuBr, wherein the silver ion compound may include at least one of AgNO₃, AgNO₃, AgNO₂, CH₃COOAg, CH₃CH(OH)COOAg, AgBF₄, AgPF₆, AgCF₃SO₃, AgClO₄, and Ag₂SO₄. The spike reductant may include at least one of L-ascorbic acid (LAA), citric acid, sodium borohydride, and hydroquinone (HQ), wherein the functional-group introducing agent may include at least one of carboxyl-PEG-thiol, methoxy-PEG-thiol, thiol-PEG-thiol, thiol-PEG-amine, methoxy-PEG-amine, carboxyl-PEG-amine, and amine-PEG-amine.

In one implementation of the method, the method further comprises, after forming the spike structure, forming a branch protruding from an outer surface of the spike structure, wherein the branch is formed using a branch precursor solution, wherein the branch precursor solution includes a surfactant solution, a fourth metal aqueous solution, a silver ion compound, a branch reductant, and a functional-group introducing agent.

According to the present disclosure as discussed above, the magnetic structure having the spike structure in which the movement thereof may be controlled remotely using the magnetic field that is ineffective to the human body, and the method for preparing the same may be provided.

Furthermore, according to the present disclosure, the magnetic structure with a spike structure in which the spike structure formed on the outer surface thereof may be controlled to have various shapes and sizes, and the moving speed and moving distance thereof may be controlled such that the magnetic structure may be applied to various purposes, and the method for preparing the same may be provided.

Effects of the present disclosure are not limited to the effects mentioned above, and other effects not mentioned will be clearly understood by those skilled in the art from the descriptions below.

### BRIEF DESCRIPTION OF DRAWINGS

FIG. 1 is a diagram schematically showing a preparation method of a magnetic structure according to one embodiment of the present disclosure.

FIG. 2 is a cross-sectional view of a magnetic structure according to one embodiment of the present disclosure.

FIG. 3 is a high-angle annular dark-field scanning transmission electron microscopy (HAADF-STEM) and energy-dispersive spectroscopy (EDS) mapping image of a magnetic structure according to an example of the present disclosure.

FIG. 4 is a flowchart showing the preparation method of the magnetic structure according to an embodiment of the present disclosure.

FIG. 5 is a TEM image of a prepared magnetic nanoparticle.

FIG. 6 is a TEM image of a prepared magnetic cluster.

FIG. 7 is a TEM image of a prepared magnetic cluster@amino-SiO2.

FIG. 8 is a TEM image of a prepared magnetic cluster@amino-SiO2@AuNP₂ₙₘ.

FIG. 9 is a TEM image of a prepared magnetic cluster@amino-SiO2@Au shell.

FIG. 10 is a diagram schematically showing change in a length of a spike structure based on a content of reductant in a magnetic structure according to each of Preparing Example 1 to Preparing Example 3.

FIG. 11 shows a HAADF-STEM and EDS mapping image and a VSM result of the magnetic structure according to each of Preparing Example 1 to Preparing Example 3.

FIG. 12 shows a transmission electron microscopy (TEM) image, a high-resolution TEM (HR-TEM) image, and selected area diffraction (SAD) analysis of the magnetic structure according to each of Preparing Example 1 to Preparing Example 3.

FIG. 13 is a TEM image and a SEM image showing aggregation of multiple magnetic structures according to Preparing Example 3.

FIG. 14 is a diagram schematically showing change in a thickness of the spike structure based on a content of surfactant in a magnetic structure according to each of Preparing Example 4 to Preparing Example 6.

FIG. 15 shows a HAADF-STEM and EDS mapping image and a VSM result of the magnetic structure according to each of Preparing Example 4 to Preparing Example 6.

FIG. 16 is a diagram showing TEM and HR-TEM images, and SAD analysis of the magnetic structure according to each of Preparing Example 4 to Preparing Example 6.

FIG. 17 is a diagram schematically showing change in a thickness of the spike structure based on a content of gold ions in a magnetic structure according to each of Preparing Example 7 to Preparing Example 9.

FIG. 18 is a HAADF-STEM and EDS mapping image of the magnetic structure according to each of Preparing Example 7 to Preparing Example 9.

FIG. 19 shows a diameter, an Ag/Au quantification result, and a VSM result of the spike structure of the magnetic structure according to each of Preparing Example 7 to Preparing Example 9.

FIG. 20 schematically shows formation of a branch on a surface of a spike structure in a magnetic structure according to each of Preparing Example 10 to Preparing Example 12.

FIG. 21 shows a HAADF-STEM and EDS mapping image and a VSM result of the magnetic structure according to each of Preparing Example 10 to Preparing Example 12.

FIG. 22 is a diagram showing TEM and HR-TEM images, and SAD analysis of the magnetic structure according to Preparing Example 10.

FIG. 23 is a TEM image of a magnetic structure with an average diameter adjusted to 50 nm.

FIG. 24 is high-and low-magnification fluorescence images of a magnetic structure conjugated with FITC (fluorescein isothiocyanate) and having an average diameter adjusted to 50 nm.

FIG. 25 is a diagram schematically showing control of the magnetic structure according to the present disclosure.

### DETAILED DESCRIPTIONS

The specific details of other embodiments are contained in the detailed description and drawings.

Advantages and features of the present disclosure, and a method to achieve the same will become apparent with reference to the embodiments described below in detail in conjunction with the accompanying drawings. However, the present disclosure is not limited to the embodiments disclosed below and may be implemented in a variety of different forms. Unless otherwise specified in following descriptions, all of numbers, values, and/or expressions indicating ingredients, reaction conditions, and contents of ingredients in the present disclosure are, in essence, approximations thereof based on various uncertainties in measurements which occur in obtaining the numbers, values, and/or expressions. Thus, the numbers, values and/or expressions should be understood as being modified by a term “about” in all instances. Further, where a numerical range is disclosed in the present description, the range is continuous and includes a minimum value and a maximum value of the range, unless otherwise indicated. Further, where the number or the value refers to an integer, the range includes all of integers included between the minimum and the maximum of the range, unless otherwise indicated. Further, in the present disclosure, when a variable is contained in a range, the variable

will be understood to include all values within a stated range including stated endpoints of the range. For example, a range of “5 to 10” includes values of 5, 6, 7, 8, 9, and 10, as well as any subranges such as 6 to 10, 7 to 10, 6 to 9, 7 to 9, etc. It will be understood that the variable includes any value between valid integers in a stated range such as 5.5, 6.5, 7.5, 5.5 to 8.5, and 6.5 to 9, etc. For example, a range “10% to 30%” includes all of integer values such as 10%, 11%, 12%, 13%, 30%, etc. as well as any subranges such as 10% to 15%, 12% to 18%, or 20% to 30%, etc. It will be understood that the range includes any value between valid integers within the stated range such as 10.5%, 15.5%, 25.5%, etc.

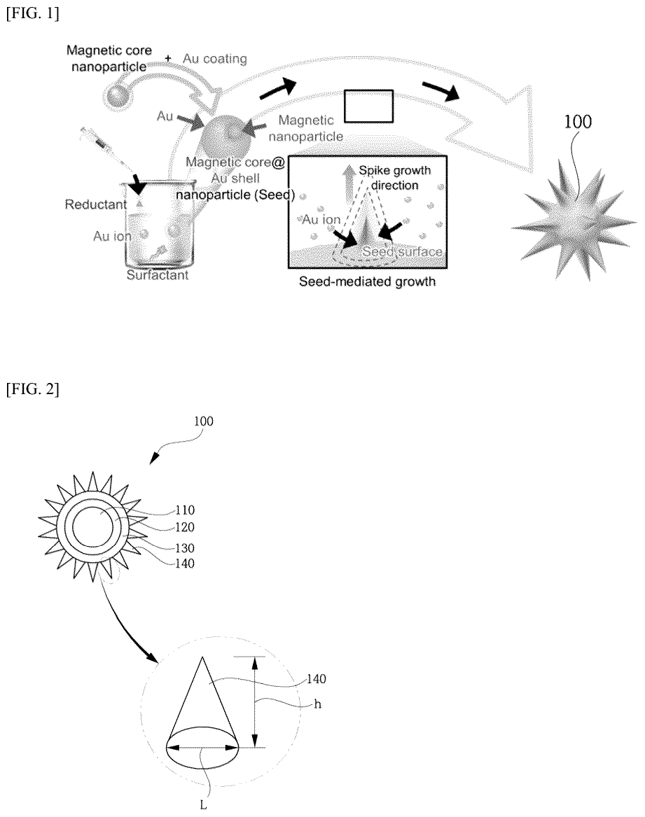

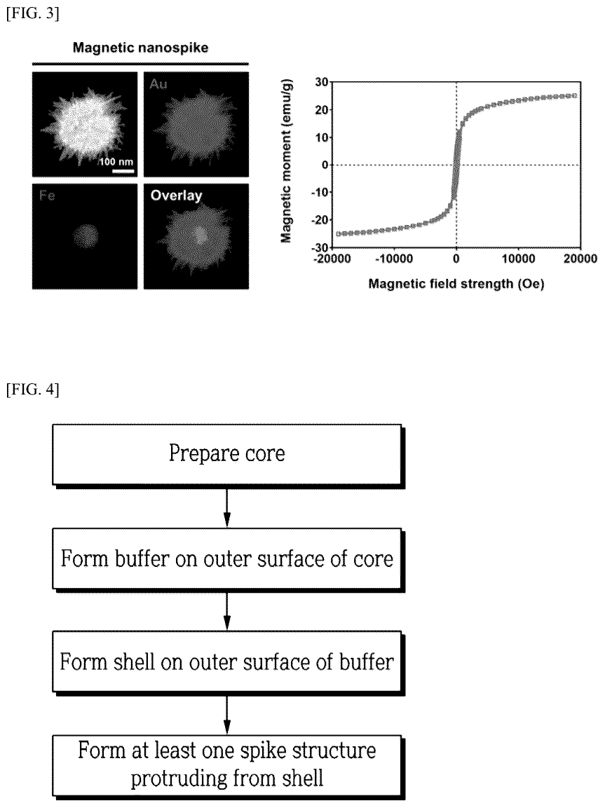

FIG. 1 is a diagram schematically showing a preparation method of a magnetic structure according to one embodiment of the present disclosure. FIG. 2 is a cross-sectional view of a magnetic structure according to one embodiment of the present disclosure. FIG. 3 is a high-angle annular dark-field scanning transmission electron microscopy (HAADF-STEM) and energy-dispersive spectroscopy (EDS) mapping image of a magnetic structure according to an example of the present disclosure.

A magnetic structure 100 having a spike structure according to one embodiment of the present disclosure may include a core 110 including at least one magnetic nanoparticle; a buffer 120 disposed on an outer surface of the core 110; a shell 130 disposed on an outer surface of the buffer 120; and at least one spike structure 140 protruding from the shell 130. The shell 130 may include at least one of a (111) crystal plane, a 100 crystal plane, and a (110) crystal plane. The spike structure 140 has a bottom surface that contacts the shell 140, and the bottom surface thereof may extend from at least a portion of the (111) crystal plane.

During the movement of particles with a needle-shaped outer surface, a mechanical force is concentrated at each vertex of the needle-shaped outer surface and transmitted to the surrounding environment. Due to its shape-specific properties such as high specific surface area and shape anisotropy thereof, research is being conducted on various synthesis methods thereof. The microneedle can pierce the skin tissue and is used for drug delivery or blood collection. However, a dynamic movement thereof should be controlled remotely, and a shape thereof should be controlled to be various.

In this regard, a dynamic movement of the magnetic structure 100 according to the present embodiment may be controlled under a magnetic field applied externally. Specifically, the magnetic structure 100 may be provided in various ways to suit the purpose depending on an intensity of the magnetic field applied externally, a size of the magnetic structure, and a size of the core.

The magnetic structure 100 may include the magnetic core 110, the buffer 120 for attaching the core 110 and the shell 130 to each other, and for controlling the size of the magnetic structure 100, the shell 130 having a crystal plane, and the spike structure 140 protruding from the shell 130 in a needle-shaped shape. The spike structure 140 may have a bottom surface, and a conical structure protruding from the bottom surface in a tapered manner, wherein the bottom surface may extend from the crystal plane.

The spike structure 140 may further include a plurality of branches protruding from the outer surface thereof. The branch may extend from at least a portion of the (111) crystal plane of the outer surface of the spike structure 140, and may be formed in a cone shape with a bottom surface as a similar shape to the shape of the spike structure 140.

Furthermore, the spike structure or the branch may include a nanotwin structure.

The twin refers to a structure in which two crystal grains are symmetrically arranged around a twin plane. The nanotwin means that a distance between twin planes is as small as nanoscale. Like a grain boundary in grain refinement, the twin plane of the twin restricts the movement of dislocations to increases the mechanical strength of the material. However, unlike the grain boundary that exhibits a large angle difference in a crystal direction, the twin plane is a coherent interface and does not serve as a scattering path for electron movement.

The spike structure or the branch according to the present embodiment includes the nanotwin structure, and thus has high mechanical strength despite its small size and has anti-wear ability due to external forces, and thus may be applied to various purposes.

An average diameter of the bottom surface of the spike structure 140 is a first length L, and a height of the spike structure 140 is a second length h. A ratio of the second length h to the first length L may be in a range of 3 to 5. When the ratio of the second length h to the first length L is smaller than 3, the spike structure does not have a needle-shaped shape with a sharp vertex. When the ratio is greater than 5, the mechanical strength of the spike structure is reduced. Furthermore, the bottom surface of the spike structure may have at least one of circular, triangular, square, and polygonal shapes. Specifically, the bottom surface of the spike structure may be circular.

Specifically, the first length may be in a range of 10 nm to 35 nm, and the second length may be in a range of 30 nm to 80 nm.

The core 110 may include at least one magnetic nanoparticle. Specifically, the core 110 may be embodied as a single magnetic nanoparticle, or a cluster of a plurality of magnetic nanoparticles. An average diameter of the magnetic nanoparticle may be in a range of 5 nm to 15 nm. The core may have paramagnetic properties and may have an average diameter of 10 nm to 700 nm. Furthermore, an average diameter of the magnetic structure may be in a range of 50 nm to 800 nm.

When the average diameter of the magnetic nanoparticle is smaller than 5 nm, it is difficult to control the magnetic nanoparticles so as to have a uniform size. When the average diameter thereof exceeds 15 nm, the production cost thereof increases significantly, which is problematic. Specifically, the average diameter of the magnetic nanoparticle may in a range of be 7 nm to 12 nm, and more specifically, the average diameter of the magnetic nanoparticle may be 10 nm. When the average diameter of the core 110 is smaller than 10 nm, it is difficult to form the shell 130 thereon. When the average diameter of the core 110 is greater than 700 nm, it is difficult to form the spike structure 140 thereon. Specifically, the average diameter of the core 110 may be in a range of 10 nm to 600 nm, or 10 nm to 500 nm.

The average diameter of the magnetic structure refers to an average diameter including a size of the spike structure 140. When the vertices of the spike structures 140 are connected to each other, an approximately spherical shape may be obtained. Thus, the average diameter of the magnetic structure refers to the average diameter of the spherical shape. When the average diameter of the magnetic structure is smaller than 50 nm, it is difficult to form the spike structure 140. When the average diameter of the magnetic structure is greater than 800 nm, it is difficult to use the magnetic properties of the core 110 under an external magnetic force.

The core 110 may include at least one of Fe₃O₄, Fe₂O₃, CoFe₂O₄, MnFe₂O₄, CoPt, and FePt.

The buffer 120 may include at least one of functional-group introduced silica (SiO₂), amine-silica, and thiol-silica. Each of the shell 130 and the spike structure 140 may include gold (Au), silver (Au), and gold-silver (Ag—Au) alloy.

The buffer 120 may have an average thickness of 10 nm to 100 nm, and the shell 130 may have an average thickness of 10 nm to 20 nm.

When the average thickness of the buffer 120 is smaller than 10 nm, it is difficult to uniformly coat the outer surface of the core 110 with the buffer 120, and thus the adhesion power of the shell 130 onto the buffer 120 is reduced. When the average thickness of the buffer 120 exceeds 100 nm, the volume of the magnetic structure 100 may be unnecessarily increased, thereby reducing production efficiency thereof. Furthermore, when the average thickness of the shell 130 is smaller than 10 nm, the crystal plane of the shell 130 is not sufficiently formed such that it is difficult to form the spike structure 140 on the shell. The average thickness of the shell 130 may be preferably 20 nm. When the average thickness of the shell 130 exceeds 20 nm, this increases unnecessarily the production cost.

The magnetic structure 100 has paramagnetic property, and the movement of the magnetic structure 100 may be controlled by applying an external magnetic field thereto. Furthermore, the paramagnetic property of the magnetic structure 100 may be due to the core 110. Thus, as the average diameter of the core 110 increases, the moving speed of the magnetic structure 100 increases. Thus, a stab movement of a vertex of the spike structure 140 of stabbing a surrounding object may be controlled by controlling the movement speed of the magnetic structure 100.

Remotely controlling the movement of the magnetic structure 100 according to the present embodiment may allow a mechanical force to be concentrated at each vertex of the spike structure 140. Furthermore, controlling the intensity of the external magnetic field, the size and shape of the magnetic structure 100 may allow the moving speed of the magnetic structure 100 to be controlled such that the magnetic structure 100 may be applied to various fields.

In another embodiment of the present disclosure, the magnetic structure 100 may be embodied as an aggregate of a plurality of magnetic structures 100 in which the plurality of magnetic structures 100 may be connected to each other via a first bond or a second bond. The first bond includes a magnetic force caused by the application of the external magnetic field. The second bond may include π-π interaction due to the magnetic structure.

The aggregate of the plurality of magnetic structures 100 may have at least one of a structure in which the plurality of magnetic structures 100 are one-dimensionally arranged and connected to each other via the first bond, a structure in which the plurality of magnetic structures 100 are arranged in a two-dimensional manner and connected to each other via the first bond or the second bond, and a structure in which the plurality of magnetic structures 100 are arranged in a three-dimensional manner and connected to each other via the first bond or the second bond.

Furthermore, the magnetic structure 100 may be surface-treated with carboxyl-PEG-thiol and amine-terminated polystyrene to increase the intensity of the second bond. Specifically, when the surface of the magnetic structure 100 is made of gold (Au), the gold (Au) and the thiol functional-group of carboxyl-PEG-thiol may bind to each other via an Au—S bond. Therefore, —COOH of the functional-group introducing agent at the surface of the magnetic structure may be exposed to the outside. In this regard, the amine functional-group of the amine-terminated polystyrene binds to the —COOH functional-group via a reaction using EDC (1-Ethyl-3-[3-dimethylaminopropyl]carbodiimide)/NHS (N-hydroxysuccinimide). Thus, polystyrene may be disposed on the surface of the magnetic structure 100. In a stacked structure of the magnetic structures 100, a benzene ring resulting from the polystyrene may be disposed at each of the upper and lower surfaces of each of the magnetic structures 100 adjacent to each other. Thus, the intensity of the second bond may be increased due to the benzene ring.

FIG. 4 is a flowchart showing a preparation method of a magnetic structure according to an embodiment of the present disclosure.

Referring to FIG. 4, the method of preparing the magnetic structure having the spike structure according to the present embodiment may include preparing a core including at least one magnetic nanoparticle; coating silica on an outer surface of the core and then introducing a functional-group onto the silica to form a buffer; forming seeds on the outer surface of the buffer using a seed precursor solution, and forming a shell on an outer surface of the buffer using a shell precursor solution in the seed-mediated growth manner; and forming at least one spike structure protruding from the shell using a spike precursor solution.

The spike structure has a bottom surface in contact with the shell and has a cone shape extending in one direction and having the vertex. The average diameter of the bottom surface of the spike is the first length, and the height of the spike is the second length. The shell includes at least one of the crystal planes (111) crystal plane, the (100) crystal plane, and the (110) crystal plane. The bottom surface may extend from at least a portion of the (111) crystal plane.

The method of preparing the magnetic structure according to the present embodiment may sequentially prepare the magnetic nanoparticle, the core, the buffer formed on the outer surface of the core, the shell formed on the outer surface of the buffer, and the spike structure formed on the outer surface of the shell. The shell may be prepared by first forming the seed and then performing the seed-mediated growth. Furthermore, the method of preparing the magnetic structure may further include forming the at least one branch on the outer surface of the spike structure after forming the spike structure.

In the step of preparing the core, at least one magnetic nanoparticle may be prepared in a cluster form using an oil-in-water microemulsion scheme.

One or more prepared magnetic nanoparticles may be added to a first organic solvent and may be dispersed therein. An oil-in-water microemulsion may be prepared by adding and mixing a dispersant solution to and with the first organic solvent in which the magnetic nanoparticles are dispersed. After removing the first organic solvent from the oil-in-water microemulsion, a polymer solution is added thereto and the mixed solution is stirred to prepare the core in which a plurality of magnetic nanoparticles with an average diameter of 50 nm to 700 nm are aggregated with each other in the form of the cluster.

Specifically, the magnetic nanoparticles may be dispersed in the first organic solvent at room temperature, and then a previously prepared dispersant solution may be mixed therewith in an ultrasonic mixing manner to prepare the oil-in-water microemulsion. The first organic solvent may be evaporated away by shaking the opaque oil-in-water microemulsion using a shaker for 3 to 24 hours. After evaporating away the first organic solvent, a previously prepared polymer solution may be added thereto, and the mixed solution is shaken using a shaker for 3 to 24 hours. Thus, a cluster in which hydrophilic magnetic nanoparticles are agglomerated with each other may be prepared.

Based on 100 parts by weight of the magnetic nanoparticles, the first organic solvent of 5 parts by weight to 400 parts by weight, the dispersant solution of 1 part by weight to 100 parts by weight, and the polymer solution of 15 parts by weight to 450 parts by weight may be used.

When a content of the first organic solvent is smaller than 5 parts by weight, it is difficult to disperse the magnetic nanoparticles. When the content is greater than 400 parts by weight, it is difficult to remove the first organic solvent later. Specifically, the content of the first organic solvent may be in a range of 5 parts by weight to 200 parts by weight, or 5 parts by weight to 100 parts by weight, or 5 parts by weight to 50 parts by weight, or 5 parts by weight to 20 parts by weight. More specifically, based on 10 mg of the magnetic nanoparticles, the first organic solvent may be used in a content of 1 ml to 4 ml. When the content of each of the dispersant solution and the polymer solution is in the above-mentioned range, the magnetic nanoparticles may be easily prepared in the cluster form using the oil-in-water microemulsion scheme.

The first organic solvent may include a solvent which can disperse the magnetic nanoparticles without reacting with the magnetic nanoparticles, and which can be easily removed. Specifically, the first organic solvent may include at least one of chloroform, hexane, benzene, and toluene.

The dispersant solution may be prepared by adding at least one of dodecyltrimethylammonium bromide (DTAB), cetyltrimethylammonium bromide (CTAB), and cetyltrimethylammonium chloride (CTAC) to deionized water (DI water).

The dispersant solution may function as a surfactant in producing a microemulsion in an oil in water. When the content of the dispersant solution is smaller than 100 parts by weight, the microemulsion is not sufficiently produced. When the content exceeds 4500 parts by weight, the size of the microemulsion is too small.

In the dispersant solution, a ratio of the content of the deionized water and the

content of at least one of dodecyltrimethylammonium bromide (DTAB), cetyltrimethylammonium bromide (CTAB), and cetyltrimethylammonium chloride (CTAC) may be in a range of 1:2.5 to 1:30. Specifically, based on 10 mg of the magnetic nanoparticles, the deionized water may be used in a content of 1 ml to 4 ml, and at least one of the dodecyltrimethylammonium bromide (DTAB), cetyltrimethylammonium bromide (CTAB), and cetyltrimethylammonium chloride (CTAC) may be used in a content of 10 mg to 30 mg.

The polymer solution may improve the stability of the magnetic nanoparticle cluster in which the plurality of magnetic nanoparticles are aggregated with each other. When the content of the polymer solution is smaller than 1500 parts by weight, a form of the magnetic nanoparticle cluster is not stably fixed. When the content exceeds 4500 parts by weight, the viscosity increases, which may cause problems such as uneven coating or agglomeration on the surface of the magnetic nanoparticle cluster.

The polymer solution may be prepared by dissolving a polymer in the ethylene glycol-based compound as a solvent. The ethylene glycol-based compound may include at least one of monoethylene glycol dimethyl ether, diethylene glycol dimethyl ether, triethylene glycol dimethyl ether, and tetraethylene glycol dimethyl ether. The polymer may include at least one of polyvinylpyrrolidone (PVP) and polyacrylic acid (PAA). Specifically, the polymer may be attached to the surface of the magnetic nanoparticle cluster and bind the magnetic nanoparticles to each other. The ethylene glycol-based compound may disperse the polymer and allow the polymer to be stably attached to the surface of the magnetic nanoparticle cluster. Specifically, based on 10 mg of the magnetic nanoparticles, the ethylene glycol-based compound may be used in a content of 5 ml to 15 ml, and the polymer may be used in a content from 10 mg to 30 mg.

After forming the core, the buffer may be disposed on the outer surface of the core. The buffer may allow a subsequent formed shell thereon to be stably attached to the core.

In the step of forming the buffer, the cores may be dispersed in the second organic solvent, and then an ammonia solution or sodium hydroxide aqueous solution may be added to the second organic solvent in which the cores have been dispersed. First mixing may be performed thereon. Then, silica precursor may be added thereto and second mixing may be performed thereon. Thus, the outer surface of the core may be coated with silica. Subsequently, the silica-coated core may be dispersed in an alcohol solvent, and then, a functional-group solution may be added thereto such that a functional-group may be introduced to the surface of the silica.

The core may be added to the second organic solvent at room temperature and then the first mixing may be performed thereon using an ultrasonic apparatus. After the first mixing has been completed, the silica precursor may be added thereto and the second mixing may be performed thereon using a shaker for 0.5 to 5 hours to coat the surface of the core with silica (SiO₂). After washing the silica-coated core several times using ethanol, etc., the silica-coated cores may be dispersed in alcohol at room temperature, and the functional-group solvent may be added thereto, and third mixing may be performed thereon using a shaker for 10 to 24 hours. Thus, the functional-group may be introduced to the silica surface. After introducing the functional-group to the silica surface, the silica-coated core may be washed multiple times using ethanol and deionized water. Thus, the buffer may be formed on the core.

Based on 100 parts by weight of the core, the second organic solvent may be used in a content of 5 parts by weight to 750 parts by weight. Based on 100 parts by weight of the second organic solvent in which the cores are dispersed, a first basic solution may be used in a content of 10 parts by weight to 20 parts by weight, and the silica precursor may be used in a content of 0.05 parts by weight to 0.15 parts by weight.

Based on 100 parts by weight of the silica-coated core, the alcohol solvent may be used in a content of 100 parts by weight to 500 parts by weight, and the functional-group solution may be used in a content of 10 parts by weight to 350 parts by weight.

Based on 100 parts by weight of the core, the second organic solvent may be used in a content of 5 parts by weight to 750 parts by weight. When using the second organic solvent in the above-mentioned range, the material may be effectively used while uniformly dispersing the core. Thus, the productivity may be improved. Specifically, based on 10 mg of the core, the second organic solvent may be used in a content of 5 ml to 15 ml.

Based on 100 parts by weight of the second organic solvent in which the cores are dispersed, the first basic solution may be used in a content of 10 parts by weight to 20 parts by weight, and the silica precursor may be used in a content of 0.05 parts by weight to 0.15 parts by weight. When the content of the silica precursor is smaller than 0.05 parts by weight, it is difficult to form the shell uniformly on the surface of the core. When the content exceeds 0.15 parts by weight, the thickness of the shell increases too much. Furthermore, the first basic solution functions to adjust the pH to condense the silica precursor. When the first basic solution is used in the above-mentioned range, the shell may additionally be formed stably. Specifically, based on 10 mg of the core, the first basic solution may be used in a content of 1.2 ml to 3 ml.

Based on 100 parts by weight of the silica-coated core, the alcohol solvent may be used in a content of 100 parts by weight to 500 parts by weight, and the functional-group solution may be used in a content of 10 parts by weight to 350 parts by weight. The functional-group solution may functionalize the surface of the silica with the functional-group. When the content of the functional-group solution is smaller than 10 parts by weight, the amount of the functional-group is too small compared to the surface area of the silica, which may be problematic in terms of the functionalization. When the content exceeds 350 parts by weight, the functional group may agglomerate with each other on the surface of the silica. The alcohol solvent may be used in the above-mentioned range to disperse the silica coated cores so that the functional-group solution contacts the surface of the silica coated core. Specifically, based on 10 mg of the silica-coated core, the alcohol solvent may be used in a content of 15 mL to 35 mL, and the functional-group solution may be used in a content of 1.5 mL to 3.5 mL.

The second organic solvent may include at least one of ethanol, deionized water, and acetone. The ammonia solution is prepared by mixing an ammonia compound with deionized water. The silica precursor may include tetraethyl orthosilicate (TEOS).

The functional-group solution may include at least one of 3-aminopropyl triethoxysilane (APTES), [3-(2-Aminoethylamino) propyl] trimethoxysilane, and (3-aminopropyl)trimethoxysilane.

The alcohol solvent may include at least one of ethanol, deionized water, methanol, and acetone. The ammonia compound may include at least one of ammonium sulfate, ammonium chloride, ammonium nitrate, and ammonium phosphate.

After sequentially forming the core and buffer, the shell may be formed on the outer surface of the buffer. The shell may be formed by forming a seed and then performing the seed-mediated growth. For example, a plurality of seeds may be formed on the buffer using a seed precursor solution, and then the shell may be grown from the seeds using a shell precursor solution. The seed may be present in a particle form. The shell may be present in a bulky shell form having a substantial volume.

The seed precursor solution may include a first basic solution, a first metal aqueous solution, and a seed reductant.

The step of forming the shell may be performed by first preparing the seed precursor solution and then impregnating the cores having the buffer coated thereon with the seed precursor solution. The seed precursor solution may include seed particles with an average diameter of 1 nm to 10 nm. When the average diameter of the seed particle is smaller than 1 nm, it is difficult for the seed particle to maintain a stable structure. When the average diameter of the seed particle is greater than 10 nm, it is difficult to form a shell with a smooth surface, which is problematic.

The seed precursor solution may be prepared by adding the seed reductant to the first basic solution and first stirring the mixed solution vigorously for 2 seconds to 1 minute, and then quickly adding the first metal aqueous solution thereto and second stirring the mixed solution for 30 seconds to 5 minutes, and afterwards, maintaining a solution containing the seed particle which is yellow-brown at room temperature for 30 minutes to 5 hours.

The shell precursor solution may include a second basic solution and a second metal aqueous solution.

The shell precursor solution may be prepared by adding the second metal aqueous solution to the second basic solution and mixing the mixed solution using an ultrasonic mixer, and maintaining the mixing product at 0° C. to 10° C. for 5 hours or larger, specifically, at 2° C. to 7° C. for 16 hours or larger.

The cores having the buffer coated thereon may be first dispersed in the first dispersion solvent to prepare a first mixture. The seed precursor solution may be added to the first mixture and then, the mixed solution may be subjected to stirring to prepare the core having the buffer coated thereon, and the seeds deposited on the buffer. Specifically, the seed precursor solution may be added to the first mixture and then, mixing may be performed thereon using an ultrasonic mixer for 30 seconds to 10 minutes to prepare the core having the buffer coated thereon, and the seeds deposited on the buffer. Subsequently, a centrifugation may be performed thereon at least once using a centrifuge, and then the core having the buffer coated thereon, and the seeds deposited on the buffer may be washed at least once using deionized water.

The cores having the buffer coated thereon, and the seeds deposited on the buffer may be dispersed in the second dispersion solvent to prepare a second mixture. The shell precursor solution may be added to the second mixture, and then the mixed solution may be stirred. After the stirring has been completed, a first additive and a second additive may be sequentially added thereto, followed by stirring thereof for 0.5 to 10 hours. After the stirring has been completed, a solid material may be isolated therefrom and washed one or more times.

The first dispersion solvent may include at least one of deionized water (DI water), ethanol, methanol, and acetone.

The first basic solution may include at least one of sodium hydroxide (NaOH) aqueous solution, potassium hydroxide (KOH) aqueous solution, magnesium hydroxide (Mg(OH)₂) aqueous solution, and calcium hydroxide (Ca(OH)₂) aqueous solution. The seed reductant may include at least one of tetrakis (hydroxymethyl) phosphonium chloride (THPC), L-Ascorbic acid (LAA), citric acid, sodium borohydride, and hydroquinone (HQ).

Each of the first and second metal aqueous solutions may include at least one of HAuCl₄, HAuBr₄ AuCl, and AuBr.

The second basic solution may include at least one of K₂CO₃, Na₂CO₃, NaHCO₃, KHCO₃, (NH₄)₂CO₃, and NH₄HCO₃.

The first additive may act as a ligand that bonds to the surface of the shell to increases the structural stability of the shell. The second additive may serve as a reductant that reduces metal ions such as gold ions contained in the solution so as to grow from the seed particles.

The first additive may include bis(p-sulfonatophenyl)phenylphosphine dihydrate dipotassium salt (BSPP). The second additive may include at least one of paraformaldehyde (PFA), L-Ascorbic acid (LAA), citric acid, sodium borohydride, and hydroquinone (HQ).

Based on 100 parts by weight of the cores having the buffer coated thereon, the first metal aqueous solution may be used in a content of 5 parts by weight to 500 parts by weight, and the seed reductant may be used in a content of 0.01 parts by weight to 5 parts by weight.

Based on 100 parts by weight of the cores having the buffer coated thereon and the seeds deposited on the buffer, the second metal aqueous solution may be used in a content of 1 part by weight to 50 parts by weight, and the second basic solution may be used in a content of 10 parts by weight to 500 parts by weight.

The second basic solution may control the pH of a reaction solution, and the seed reductant may act as a reductant that reduces the metal ions contained in the solution. Furthermore, the first metal aqueous solution may provide the metal ions as a precursor to be reduced to a metal, such as gold.

The spike structure may be formed using a spike precursor solution so as to extend from the crystal plane of the shell.

The spike precursor solution may include a surfactant solution, a third metal aqueous solution, a silver ion compound, a spike reductant, and a functional-group introducing agent.

In the step of forming the spike structure, the cores having the buffer coated thereon, the third metal aqueous solution, and the silver ion compound may be added into a reactor containing therein the surfactant solution, and may be mixed with each other therein. Subsequently, a reaction may be performed in the reactor at least once for a first time at a first concentration of the spike reductant, and then the functional-group introducing agent may be added thereto and the mixed solution may be maintained for 10 minutes to 1 hour.

A concentration of the silver ion compound may be in a range of 1 mM to 20 mM, and a concentration of the surfactant may be in a range of 200 mM to 500 mM. The first concentration of the spike reductant may be in a range of 1 mM to 20 mM, and the first time may be in a range of 10 minutes to 60 minutes.

In the present embodiment, the spike structure may be formed in a form of a cone having a bottom surface and a height extending from the bottom surface. The bottom surface may extend from the crystal plane of the shell, such as the (111) crystal plane. The average diameter of the bottom surface of the spike structure may be the first length, and the height thereof may be the second length.

The first length and the second length of the spike structure may be controlled in various ways. Furthermore, the spike structure may include a twin structure.

As the concentration of the surfactant solution increases, the first length decreases. As the concentration of the surfactant decreases, the first length may increase.

As the concentration of the surfactant solution increases, an interfacial energy between a surface of the shell and the metal ions in the solution may be increased. Therefore, an anisotropic growth of the shell may be promoted such that the first length is reduced to form the spike structure, rather than growing in a layered shape around the seeds.

The number of additions of the spike reductant may be in a range of 1 to 7 times. As the number of additions of the spike reductant increases, the second length may increase. When the number of additions of the spike reductant decreases, the second length may decrease.

When the number of additions of the spike reductant increases, a reduction rate of the metal ions, such as Au³⁺ ions discharged from the second metal aqueous solution included in the spike precursor solution may be increased. Therefore, the second length of the spike structure may be increased.

A ratio (Ag⁺/Au³⁺) of the content of the silver ions contained in the silver ion compound to the content of the metal ions contained in the third metal aqueous solution may be in a range of 1 to 4. As the content of the silver ions increases, the first length may decrease. When the content of the silver ions decreases, the first length may increase.

When the ratio (Ag⁺/Au³⁺) is smaller than 1, the spike structure is not formed. when the ratio (Ag⁺/Au³⁺) is greater than 4, a density of the spike structure increases significantly, such that neighboring spike structures come into contact with each other, thereby forming a single bulky lump. Furthermore, in a process of growing the spike structure, when the ratio (Ag⁺/Au³⁺) of the content of the silver ions contained in the silver ion compound to the content of the metal ions, for example, Au³⁺ ions discharged from the second metal aqueous solution increases, a larger amount of Ag⁺ ions may be deposited on the surface of the shell, and the deposited Ag⁺ ions may be reduced to Ag atoms. The Ag atoms may act as multiple sites on the surface of the shell where the spike structure grows, thereby reducing a spacing between neighboring spike structures such that the spike structures are arranged at a very high density, and thus a collection of the spike structures has a shell-like shape.

Specifically, when the concentration of the surfactant solution is in a range of 300 mM to 500 mM and the concentration of the spike reductant is in a range of 15 mM to 20 mM, and when the number of additions of the spike reductant increases, the spike structure may have the twin structure along the (111) crystal plane while the second length thereof may increase.

Furthermore, as the concentration of the surfactant solution is lower, the spike structure may grow along the (100) crystal plane and the (110) crystal plane, and the first length may be in a range of 10 nm to 35 nm and the twin structure may be absent in the spike structure.

When the concentration of the silver ion compound increases, the density of the spike structures and the second length of the spike structure increase. When the concentration of the silver ion compound is 5 mM and a volume thereof is in a range of 20 [symbol] to 200 [symbol] , the first length may increase as the concentration of the third metal aqueous solution increases.

The surfactant solution may include at least one of 2-[4-(2,4,4-trimethylpentan-2-yl) phenoxy] ethanol, triton-X100 aqueous solution, dodecyltrimethylammonium bromide (DTAB), cetyltrimethylammonium bromide (CTAB), cetyltrimethylammonium chloride (CTAC), polyoxyethylene nonyl phenyl ether, octylphenoxy poly (ethyleneoxy) ethanol, and polyethylene glycol nonyl phenyl ether.

The third metal aqueous solution may include at least one of HAuCl₄, HAuBr₄, AuCl, and AuBr.

The silver ion compound may include at least one of AgNO₃, AgNO₃, AgNO₂, CH₃COOAg, CH₃CH(OH)COOAg, AgBF₄, AgPF₆, AgCF₃SO₃, AgClO₄, and Ag₂SO₄. The spike reductant may include at least one of L-ascorbic acid (LAA), citric acid, sodium borohydride, and hydroquinone (HQ).

The functional-group introducing agent may include at least one of carboxyl-PEG-thiol, methoxy-PEG-thiol, thiol-PEG-thiol, thiol-PEG-amine, methoxy-PEG-amine, carboxyl-PEG-amine, and amine-PEG-amine.

The functional-group introducing agent may be prepared using PEG (Polyethylene glycol). The PEG may provide a thiol functional-group or amine functional-group highly reactive with the gold surface to prevent further reduction (overgrowth) in the process in which the Au ions and the Ag ions in the solution are reduced on the metal surface by the reductant.

According to another aspect of the present disclosure, the present disclosure may further include forming the branch protruding from the outer surface of the spike structure after the step of forming the spike structure. The branch may be formed so as to protrude from the crystal plane (111) of the outer surface of the spike structure, and may have a cone shape with a bottom surface. The size and number of branches may be controlled in various ways.

A branch precursor solution may include a surfactant solution, a fourth metal aqueous solution, a silver ion compound, a branch reductant, and a functional-group introducing agent.

The surfactant solution may include at least one of 2-[4-(2,4,4-trimethylpentan-2-yl) phenoxy]ethanol, triton-X100 aqueous solution, dodecyltrimethylammonium bromide (DTAB), cetyltrimethylammonium bromide (CTAB), cetyltrimethylammonium chloride (CTAC), polyoxyethylene nonyl phenyl ether, octylphenoxy poly (ethyleneoxy) ethanol, and polyethylene glycol nonyl phenyl ether.

The fourth metal aqueous solution may include at least one of HAuCl₄, HAuBr₄, AuCl, and AuBr.

The silver ion compound may include at least one of AgNO₃, AgNO₃, AgNO₂, CH₃COOAg, CH₃CH(OH)COOAg, AgBF₄, AgPF₆, AgCF₃SO₃, AgClO₄, and Ag₂SO₄.

The branch reductant may include at least one of L-ascorbic acid (LAA), citric acid, sodium borohydride, and hydroquinone (HQ).

The functional-group introducing agent may include at least one of carboxyl-PEG-thiol, methoxy-PEG-thiol, thiol-PEG-thiol, thiol-PEG-amine, methoxy-PEG-amine, carboxyl-PEG-amine, and amine-PEG-amine.

Each of the surfactant solution, the fourth metal aqueous solution, the silver ion compound, and the branch reductant of the branch precursor solution may be made of the same material as that of each of the surfactant solution, the third metal aqueous solution, the silver ion compound, and the spike reductant of the spike precursor solution. A concentration/an addition amount of each of the surfactant solution, the fourth metal aqueous solution, the silver ion compound, and the branch reductant of the branch precursor solution may be the same as or different from the concentration/the addition amount of each of the surfactant solution, the third metal aqueous solution, the silver ion compound, and the spike reductant of the spike precursor solution.

The step of forming the branch on the surface of the spike structure may be performed by adding the cores having the buffer, the shell, and the spike structures formed thereon to the branch precursor solution.

Specifically, the cores having the buffer, the shell, and the spike structures formed thereon, the fourth metal aqueous solution, and the silver ion compound may be added into a reactor containing therein the surfactant solution, and may be quickly mixed with each other therein. Subsequently, Thereafter, the branch reductant may be added to the reactor and may be mixed therewith quickly. A reaction may be performed for 1 minute to 1 hour, and then, the functional-group introducing agent may be added thereto, and a reaction may be performed for 10 minutes to 3 hours. Subsequently, the reaction product may be washed one or more times using deionized water such that a residue may be removed therefrom.

As the addition amount of the branch reductant increases, the number of branches may increase.

Hereinafter, Present Examples and Comparative Examples of the present disclosure are described. However, the following Examples are merely preferred embodiments of the present disclosure, and the scope of rights of the present disclosure is not limited to the following Examples.

### PREPARING MAGNETIC STRUCTURE WITH SPIKE STRUCTURE

### 1. Preparing Magnetic Nanoparticles

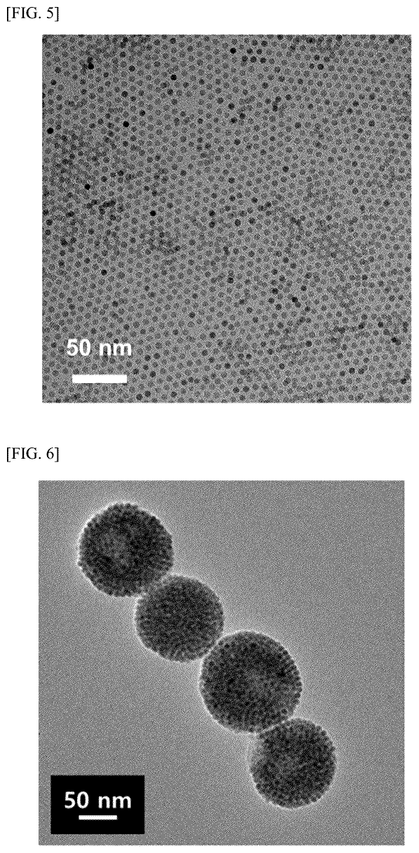

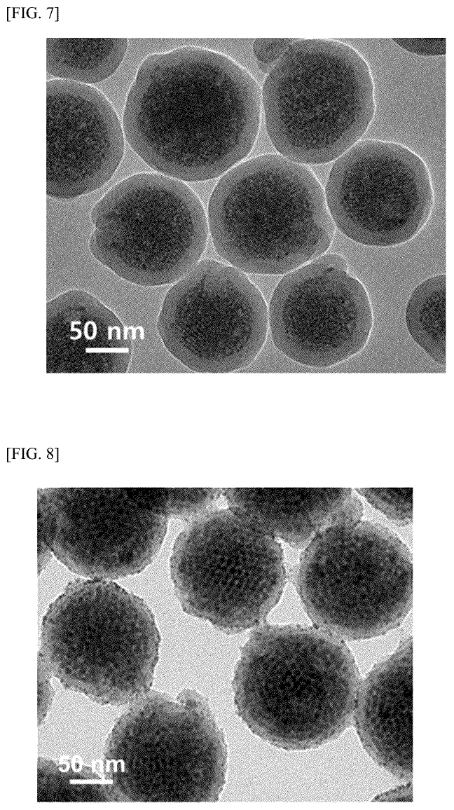

To produce iron oleate complex, we added 1.8 mL of oleic acid (Daejeong Chemical Co., Ltd., 5635-4400) to 20 mL of 1-octadecene (Sigma-Aldrich, 0806), followed by stirring and mixing. A temperature was raised to 100° C. Afterwards, 0.4 mL of iron(0) pentacarbonyl, Sigma-Aldrich, 481718) was injected thereto and the mixture was maintained for 20 min to prepare a mixed solution. The prepared mixed solution was refluxed at 180° C. for 1 h and cooled to room temperature. To prepare magnetic nanoparticles, the mixed solution cooled to the room temperature was heated to 320° C. in a nitrogen atmosphere and was maintained for 1 h. After the reaction had been completed, the reaction product was cooled to room temperature, and a solid material was separated therefrom and washed three times with ethanol. After washing had been completed, 100 mg of the magnetic nanoparticles were dispersed in 10 mL of chloroform. FIG. 5 is a TEM image of the prepared magnetic nanoparticles.

### 2. Preparing Magnetic Cluster Using Magnetic Nanoparticles and Coating Magnetic Cluster With Amino-SiO₂

A process of assembling the magnetic nanoparticles with each other was performed to prepare the magnetic cluster. In order to prepare an oil-in-water microemulsion, 10 mL of chloroform in which the magnetic nanoparticles were dispersed was added to a mixed solution in which 20 mg dodecyltrimethylammonium bromide (DTAB, Sigma-Aldrich, D8638) was dissolved in 2 mL of deionized water, followed by mixing for 5 minutes using an ultrasonic apparatus (Hwashin Tech, POWERSONIC610) at a maximum strength. An opaque oil-in-water microemulsion solution was shaken with a shaking apparatus (Daehan Science, SHR-2D) at 120 rpm for 16 hours to evaporate away the chloroform present in the oil-in-water microemulsion solution. To the resultant solution, we added a mixed solution in which 20 mg of polyvinylpyrrolidone (PVP, molecular weight: 55 kDa, Sigma-Aldrich, 856568) was dissolved in 10 mL of ethylene glycol (Sigma-Aldrich, 324558), followed by shaking thereof at 120 rpm for 16 hours using a shaking apparatus. Thereafter, a solid material was isolated therefrom and washed three times using deionized water. The prepared magnetic cluster was hydrophilic and had an average diameter of 150 nm. 250 mg of the magnetic clusters were dispersed in 25 mL of ethanol. FIG. 6 is a TEM image of the prepared magnetic cluster.

In order to attach a gold nanoparticle seed (AuNP2 nm) for preparing a gold shell (Au shell) to the magnetic cluster, amino-SiO₂ was coated on the surface of the magnetic cluster. 500 uL of 28wt % ammonia solution (Junsei, 13370-3330) and 1.5 mL of deionized water were added to 10 mL of ethanol in which the previously prepared magnetic clusters were dispersed, followed by mixing thereof for 5 minutes using an ultrasonic apparatus at the maximum mixing strength of the apparatus. Then, 10 uL of tetraethyl orthosilicate (TEOS, Junsei, 29025-1501) was added thereto, followed by shaking thereof with a shaking apparatus at 120 rpm for 1 hour. The prepared SiO₂-coated magnetic clusters (magnetic cluster@SiO₂) were washed three times using ethanol, and then, 250 mg of magnetic cluster@SiO₂ were dispersed in 25 mL of ethanol to prepare a magnetic cluster@SiO₂ suspension solution. We added 1 mL of 3-aminopropyl triethoxysilane (APTES, Sigma-Aldrich, 440140) to 10 mL of the prepared magnetic cluster@SiO₂ suspension solution, followed by shaking with a shaking apparatus at 120 rpm for 16 hours to introduce the amino functional-group (amino functionalization) to the silica surface to prepare the amino-SiO₂ coated magnetic clusters (magnetic cluster@amino-SiO₂). The amino-SiO₂ coated magnetic clusters (magnetic cluster@amino-SiO₂) were subjected to washing three times using ethanol and deionized water, and then 20 mg of magnetic cluster@amino-SiO₂ were dispersed in 2 mL of deionized water.

### 3. Preparing Gold Nanoparticles (AuNP₂ nm)

16 uL of tetrakis (hydroxymethyl) phosphonium chloride (THPC, Sigma-Aldrich, 404861) was added to 60 mL of 11 mM NaOH aqueous solution, followed by vigorously stirring for 10 sec. 2.4 mL of 1 wt % HAuCl₄·3H₂O (Sigma-Aldrich, 520918) was quickly injected thereto, followed by additional stirring for 1 min. Afterwards, the AuNP₂ nm solution which was yellow-brown and contained particles of a size of 2 nm was stabilized for 2 hours and then used without washing.

### 4. Preparing Magnetic Cluster (Core)-Amino-SiO₂ (Buffer)-Gold (Shell) (Magnetic Cluster@Amino-SiO₂@Au Shell) Via Seed Mediated Growth

To prepare the magnetic cluster (core)-amino-SiO₂ (buffer)-gold particles (magnetic cluster@amino-SiO₂@AuNP₂ nm), 5 mL of AuNP₂ₙₘ solution and 2 mL of magnetic cluster@amino-SiO₂ solution were mixed with each other for 5 mins using an ultrasonic apparatus at the maximum strength of the apparatus. The prepared mixture was subjected to isolation at 10000 rpm for 5 mins a total of 3 times using a centrifugal isolation apparatus (Hanil Science, Combi R515). The isolation product was washed three times with deionized water, and then, 100 mg of magnetic cluster@amino-SiO₂@AuNP₂ₙₘ as thus-obtained solid material were suspended in 10 mL of deionized water. FIG. 8 is a TEM image of a prepared magnetic cluster@amino-SiO₂@AuNP₂ₙₘ.

To prepare the shell precursor solution, 150 uL of 10% (w/v) HAuCl₄·3H₂O was added to 200 mL of 1 mM K₂CO₃ aqueous solution (Sigma-Aldrich, 209619). The thus-prepared mixed solution was stirred for 1 min using an ultrasonic apparatus at the maximum intensity of the apparatus, and then was aged at 4° C. for 24 hours before use.

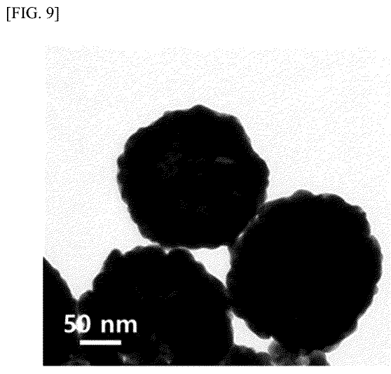

In order to grow the AuNP₂ₙₘ attached to the surface in a form of a shell in a seed mediated scheme, the previously prepared shell precursor solution was used. 500 uL of magnetic cluster@amino-SiO₂@AuNP₂ₙₘ was added to 42.4 mL of shell precursor solution, followed by stirring to prepare a mixture. 2 mL of 0.1% (w/v) bis(p-sulfonatophenyl)phenylphosphine dihydrate dipotassium salt (BSPP, Sigma-Aldrich, 698539), and 500 uL of 4% (w/v) paraformaldehyde (PFA, Sigma-Aldrich, 252549) were sequentially added to the mixture, followed by stirring and mixing for 3 hours. The isolation was performed thereon a total of 3 times at 10000 rpm using a centrifugal apparatus, wherein 5 minutes was consumed per each time. The mixture was washed twice with deionized water, and 50 mg of the thus prepared magnetic cluster@amino-SiO₂@Au shell were dispersed in 5 mL of deionized water. FIG. 9 is a TEM image of a prepared magnetic cluster@amino-SiO₂@Au shell.

### 5. Spike Structure Formation

### Preparing Example 1 to Preparing Example 3 (Control of Protrusion Length of Spike Structure)

As described in a following table 1, the previously prepared magnetic cluster@amino-SiO₂@Au shell, HAuCl₄·3H₂O, and AgNO₃ were sequentially added to the triton-X100 aqueous solution (Sigma-Aldrich, X100), and were mixed with each other. LAA was rapidly injected thereto and mixed therewith once (Short), twice (Moderate), and three times (Long) at 10 min intervals. 200 uL of 1 mM carboxyl-PEG-thiol (Laysan Bio, Inc., 170-54) as a PEG linker was added thereto, followed by mixing for 30 mins. The mixture was washed three times with deionized water to form multiple spike structures (magnetic cluster@amino-SiO₂@Au shell@Au spike) on the outermost surface of the magnetic cluster@amino-SiO₂@Au shell.

TABLE 1

| | | | Volume of | Volume of | | |
|---|---|---|---|---|---|---|
| | | Concentration of | 5 mM | 5 mM | Concentration of | Number of |
| Example | Length | Triton-X100 | HAuCl₄•3H₂O | AgNO₃ | LAA | adding LAA |
| Preparing | Long | 500 mM | 500 uL | 20 uL | 20 mM | 3 |
| Example 1 | | | | | | |
| Preparing | Medium | 500 mM | 500 uL | 20 uL | 20 mM | 2 |
| Example 2 | | | | | | |
| Preparing | Short | 500 mM | 500 uL | 20 uL | 20 mM | 1 |
| Example 3 | | | | | | |

### Preparing Example 4 to Preparing Example 6 (Control of Thickness of Spike Structure)

As described in a following table 2, the previously prepared magnetic cluster@amino-SiO₂@Au shell, HAuCl₄·3H₂O, and AgNO₃ were sequentially added to the triton-X100 aqueous solution (Sigma-Aldrich, X100) at various concentrations (20 mM, 100 mM, and 500 mM) of the triton-X100 aqueous solution, and were mixed with each other. LAA was rapidly injected thereto and mixed therewith for 10 mins. 200 uL of 1 mM carboxyl-PEG-thiol (Laysan Bio, Inc., 170-54) as a PEG linker was added thereto, followed by mixing for 30 mins. The mixture was washed three times with deionized water to form multiple spike structures (magnetic cluster@amino-SiO₂@Au shell@Au spike) on the outermost surface of the magnetic cluster@amino-SiO₂@Au shell.

TABLE 2

| | | | Volume of | Volume of | | |
|---|---|---|---|---|---|---|
| | | Concentration of | 5 mM | 5 mM | Concentration of | Number of |
| Example | Thickness | Triton-X100 | HAuCl4•3H2O | AgNO3 | LAA | adding LAA |
| Preparing | Thick | 20 mM | 500 uL | 20 uL | 20 mM | 1 |
| Example 4 | | | | | | |
| Preparing | Moderate | 100 mM | 500 uL | 20 uL | 20 mM | 1 |
| Example 5 | | | | | | |
| Preparing | Thin | 500 mM | 500 uL | 20 uL | 20M | 1 |
| Example 6 | | | | | | |

### Preparing Example 7 to Preparing Example 9 (Control of Thickness of Spike Structure)

As described in a following table 3, the previously prepared magnetic cluster@amino-SiO₂@Au shell, HAuCl₄·3H₂O, and AgNO₃ were sequentially added to the triton-X100 aqueous solution (Sigma-Aldrich, X100), and were mixed with each other. In this regard, 50 uL of HAuCl₄1·3H₂O was added at various volumes (Present Example 7: 200 uL, Present Example 8: 100 uL, and Present Example 9: 50 uL). LAA was rapidly injected thereto and mixed therewith for 10 mins. 200 uL of 1 mM carboxyl-PEG-thiol (Laysan Bio, Inc., 170-54) as a PEG linker was added thereto, followed by mixing for 30 mins. The mixture was washed three times with deionized water to form multiple spike structures (magnetic cluster@amino-SiO₂@Au shell@Au spike) on the outermost surface of the magnetic cluster@amino-SiO₂@Au shell.

TABLE 3

| | | | Volume of | Volume of | | |
|---|---|---|---|---|---|---|
| | | Concentration of | 5 mM | 5 mM | Concentration of | Number of |
| Example | Thickness | Triton-X100 | HAuCl₄•3H₂O | AgNO₃ | LAA | adding LAA |
| Preparing | Large | 500 mM | 200 uL | 200 uL | 20 mM | 1 |
| Example 7 | | | | | | |
| Preparing | Moderate | 500 mM | 100 uL | 200 uL | 20 mM | 1 |
| Example 8 | | | | | | |
| Preparing | Small | 500 mM | 50 uL | 200 uL | 20 mM | 1 |
| Example 9 | | | | | | |

### Preparing Example 10 to Preparing Example 12 (Control of Formation of Branch on Surface of Spike Structure)

As described in a following table 4, the magnetic cluster@amino-SiO₂@Au shell@Au spike according to Preparing Example 2, HAuCl₄1·3H₂O, and AgNO₃ were sequentially added to the triton-X100 aqueous solution (Sigma-Aldrich, X100), and were mixed with each other. LAA was rapidly injected thereto and mixed therewith for 10 mins. In this regard, the concentration of LAA was controlled in various manner (Present Example 12:1 mL (“Low” branching), Present Example 11:10 mM (“Moderate” branching), and Present Example 10:20 mM (“High” branching). 200 uL of 1 mM carboxyl-PEG-thiol (Laysan Bio, Inc., 170-54) as a PEG linker was added thereto, followed by mixing for 30 mins. The mixture was washed three times with deionized water to form the branches on the outermost surface of the spike structure of the magnetic cluster@amino-SiO₂@Au shell@Au spike.

TABLE 4

| | | | Volume of | Volume of | | |
|---|---|---|---|---|---|---|
| | Branch | Concentration of | 5 mM | 5 mM | Concentration of | Number of |
| Example | density | Triton-X100 | HAuCl₄•3H₂O | AgNO₃ | LAA | adding LAA |
| Preparing | High | 500 mM | 135 uL | 65 uL | 20 mM | 1 |
| Example 10 | | | | | | |
| Preparing | Moderate | 500 mM | 135 uL | 65 uL | 10 mM | 1 |
| Example 11 | | | | | | |
| Preparing | Low | 500 mM | 135 uL | 65 uL | 1 mM | 1 |
| Example 12 | | | | | | |

### Preparing Example 13 (Diameter 50 nm)

As described in a following table 5, the previously prepared magnetic cluster@amino-SiO₂@Au shell, HAuCl₄·3H₂O, and AgNO₃ were sequentially added to the triton-X100 aqueous solution (Sigma-Aldrich, X100), and were mixed with each other. LAA was rapidly injected thereto and mixed therewith for 10 mins. 200 uL of 1 mM carboxyl-PEG-thiol (Laysan Bio, Inc., 170-54) as a PEG linker was added thereto, followed by mixing for 30 mins. The mixture was washed three times with deionized water to form multiple spike structures (magnetic cluster@amino-SiO₂@Au shell@Au spike) on the outermost surface of the magnetic cluster@amino-SiO₂@Au shell.

| | | | Volume of | Volume of | | |
|---|---|---|---|---|---|---|
| | | Concentration of | 10 mM | 10 mM | Concentration of | Number of |
| Example | Diameter | Triton-X100 | HAuCl₄•3H₂O | AgNO₃ | LAA | adding LAA |
| Preparing | 50 nm | 500 mM | 500 uL | 10 uL | 25 mM | 1 |
| Example 13 | | | | | | |

### Evaluation of Magnetic Structure With Spike Structure

### Preparing Example 1 to Preparing Example 3 (Control of Protrusion Length of Spike Structure)

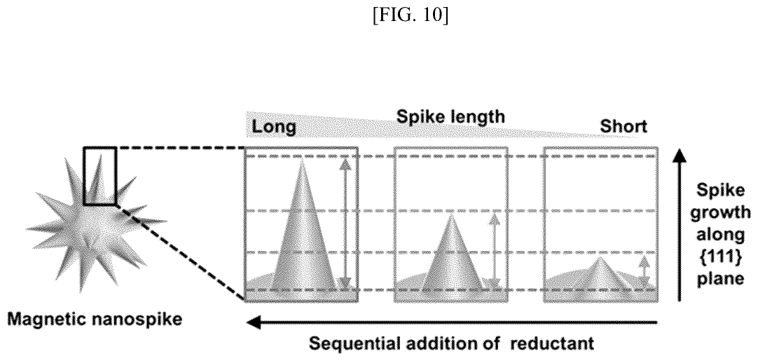

FIG. 10 to FIG. 13 are the results of evaluating the magnetic structures according to Preparing Example 1 to Preparing Example 3.

FIG. 10 is a diagram schematically showing the change in the length of the spike structure based on a content of the reductant in the magnetic structure according to each of Preparing Example 1 to Preparing Example 3. Referring to FIG. 10, in the magnetic structure according to the embodiment of the present disclosure, the length of the spike becomes larger as the amount of LAA as the reductant increases in the process of preparing the spike structure. Furthermore, the spike structure grows along the (111) crystal plane among the crystal planes of the gold shell.

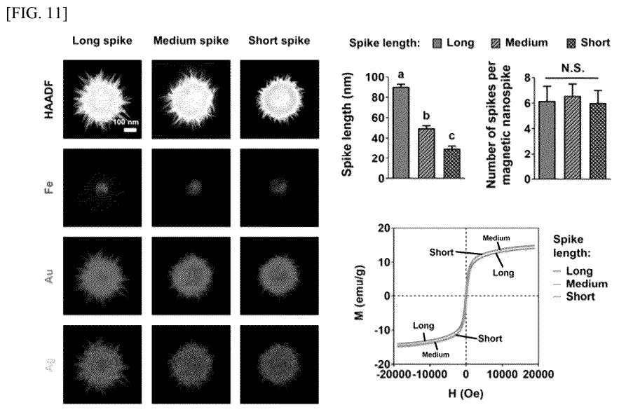

FIG. 11 shows the HAADF-STEM and EDS mapping image and the VSM result of the magnetic structure according to each of Preparing Example 1 to Preparing Example 3. Table 6 shows the average length of the spike structure of the magnetic structure and the average number of spikes per one magnetic structure according to each of Preparing Example 1 to Preparing Example 3.

| | | | | | Number of |
|---|---|---|---|---|---|
| | | | Diameter of | Length of | spikes per |
| | Spike | Number of | magnetic | magnetic | magnetic |
| Example | length | adding LAA | nanospike | nanospike | structure |
| Preparing | Long | 3 | 16 nm | 78 nm | 300 |
| Example 1 | | | | | |
| Preparing | Medium | 2 | 16 nm | 65 nm | 300 |
| Example 2 | | | | | |
| Preparing | Short | 1 | 16 nm | 40 nm | 300 |
| Example 3 | | | | | |

In FIG. 11, referring to the HAADF-STEM results of iron (Fe), gold (Au), and silver (Ag) elements constituting the magnetic structure, the magnetic nanoparticles are aggregated with each other to constitute the core, and the gold and silver elements are present in the shell and the spike structure. Furthermore, it was identified that when comparing Preparing Example 1 to Preparing Example 3 with each other in which the number of additions of LAA was 3 times, 2 times, and 1 time, respectively, the length of the spike structure increased as the number of additions of LAA increased. On the contrary, it was identified that even when the number of additions of LAA increased, the average diameter of the magnetic nanospike remained constant, and the number of spike structures per the magnetic structure remained constant. Furthermore, the VSM results of Preparing Example 1 to Preparing Example 3 exhibited similar values.

In other words, paramagneticity is due to the core of the magnetic structure. Thus, Preparing Example 1 to Preparing Example 3 with similar core sizes exhibited similar characteristics. Furthermore, as the LAA content increased, the length of the spike structure increased, but the number of spike structures remained constant. In other words, it is identified that when a diameter of the bottom surface of the spike structure is maintained to be constant despite of increase in the number of additions of LAA as the reductant, the length of the spike structure can be larger when the number of additions of LAA increases.

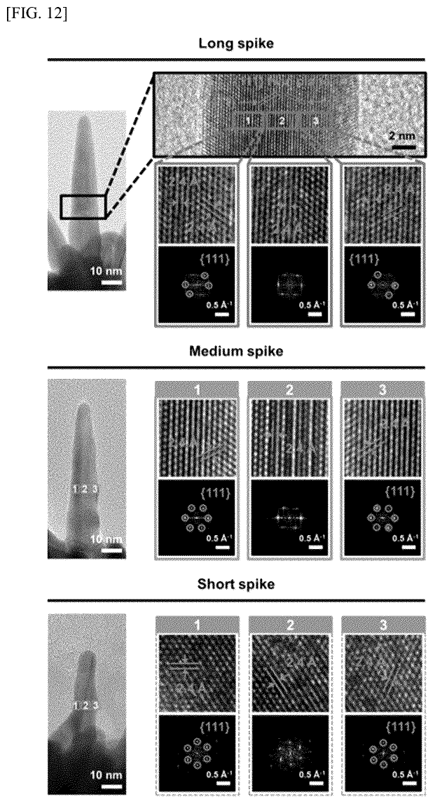

FIG. 12 shows transmission electron microscopy (TEM) and high-resolution TEM (HR-TEM) images, and selected area diffraction (SAD) analysis of the magnetic structure according to each of Preparing Example 1 to Preparing Example 3.

Referring to FIG. 12, it was identified that the spike structure grown under the same content of the surfactant, that is, Triton-X100 has the twin structure along the (111) crystal plane of the gold shell. In the magnetic structure according to each of Preparing Example 1 to Preparing Example 3, regardless of the number of times the reductant was added, the spike structure grew along the (111) crystal plane among the crystal planes of the gold shell and had the twin structure with (111) crystal planes at both opposing sides around the (111) crystal plane.

In other words, the increase in the number of injections of LAA as the reductant may quickly promote the reduction of Au³⁺ ions present in the spike precursor solution such that the length of the spike structure may be larger.

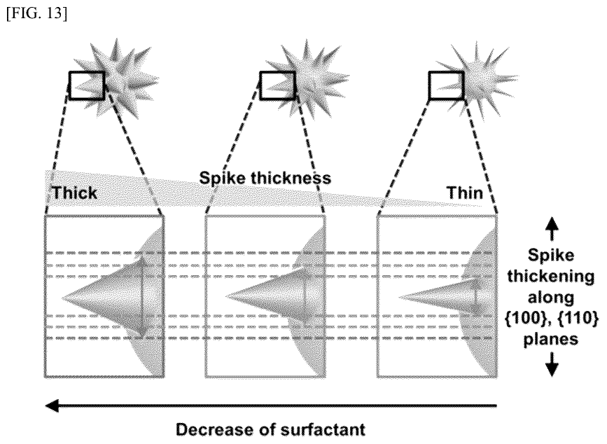

FIG. 13 is TEM and SEM images showing the aggregation of multiple magnetic structures according to Preparing Example 3. In FIG. 13, it may be identified that when the magnetic force is applied externally thereto, the magnetic structures are aggregated with each other in each of a 1-dimensional (1D), 2-dimensional (2D), and 3-dimensional (3D) manners.

The magnetic structure according to the embodiment of the present disclosure includes the magnetic nanoparticle cluster as the core, and thus has the paramagnetic property. Thus, the movement thereof may be controlled under the magnetic force applied from an external source. As the size of the core increases, the movement speed due to the magnetic force may increase. When the magnetic field is externally applied thereto, the magnetic structures move, and thus, neighboring magnetic structures aggregate with each other to form an aggregate. Furthermore, under the application of the external magnetic field thereto, the magnetic structures may be arranged in one-dimensional (line) structure, or in a two-dimensional (plane) manner via π-π stacking in a planar shape, or in a three-dimensional (sphere) manner via π-π stacking in a spherical shape.

### Preparing Example 4 to Preparing Example 6 (Control Thickness of Spike Structure)

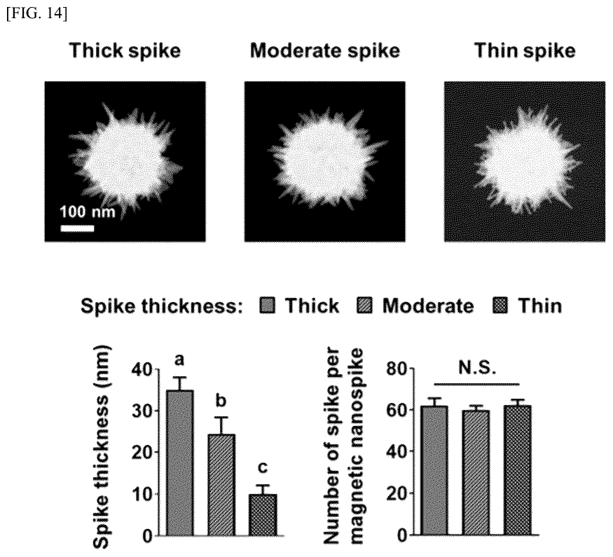

FIG. 14 to FIG. 17 are the results of evaluating the magnetic structures according to Preparing Example 4 to Preparing Example 6.

FIG. 14 is a diagram schematically showing change in a thickness of the spike structure based on a content of the surfactant in the magnetic structure according to each of Preparing Example 4 to Preparing Example 6. Referring to FIG. 14, as the content of the surfactant decreases, the thickness of the spike structure and the length of the bottom surface thereof increase. The bottom surface of the spike structure becomes thick from the (111) crystal plane along the (100) crystal plane or the (110) crystal plane.

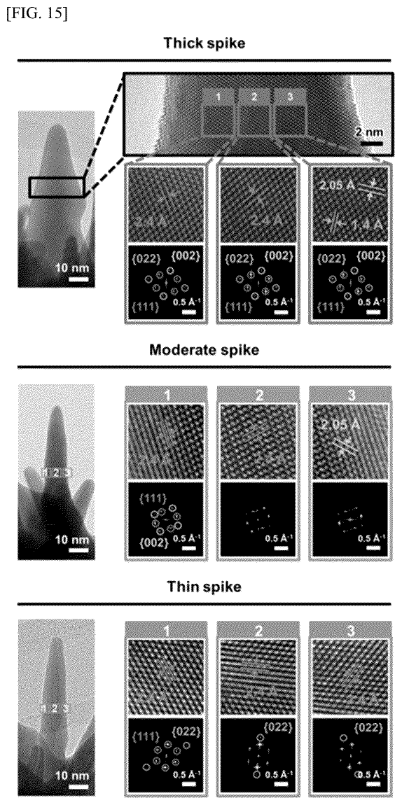

FIG. 15 shows the HAADF-STEM and EDS mapping image and the VSM result of the magnetic structure according to each of Preparing Example 4 to Preparing Example 6. Table 7 shows the results showing the average length of the spike structure of the magnetic structure and the average number of spikes per one magnetic structure according to each of Preparing Example 4 to Preparing Example 6.

TABLE 7

| | | | | | Number of |
|---|---|---|---|---|---|
| | | | Diameter of | Length of | spikes per |
| | | Concentration of | magnetic | magnetic | magnetic |
| Example | Thickness | Triton-X100 | nanospike | nanospike | structure |
| Preparing | Thick | 20 mM | 35 nm | 60 nm | 300 |
| Example 4 | | | | | |
| Preparing | Moderate | 100 mM | 20 nm | 60 nm | 300 |
| Example 5 | | | | | |
| Preparing | Thin | 500 mM | 10 nm | 60 nm | 300 |
| Example 6 | | | | | |

Referring to FIG. 15 and Table 7, in the magnetic structure according to each of Preparing Example 4 to Preparing Example 6, as the content of Triton-X100 as the surfactant increases, the thickness (diameter of magnetic nanospike) as the diameter of the bottom surface of the spike structure decreases. On the contrary, it is identified that the numbers of spike structures per one magnetic structure in Preparing Example 4 to Preparing Example 6 are equal to each other. That is, since the number of (111) crystal planes formed in the gold shell is constant, the number of spike structures is constant as the content of Triton-X100 as the surfactant increases. It is identified that as the surfactant content is lower, the bottom surface of the spike structure protruding from the (111) crystal plane extends in the (100) crystal plane or the (110) crystal plane and thus is larger.

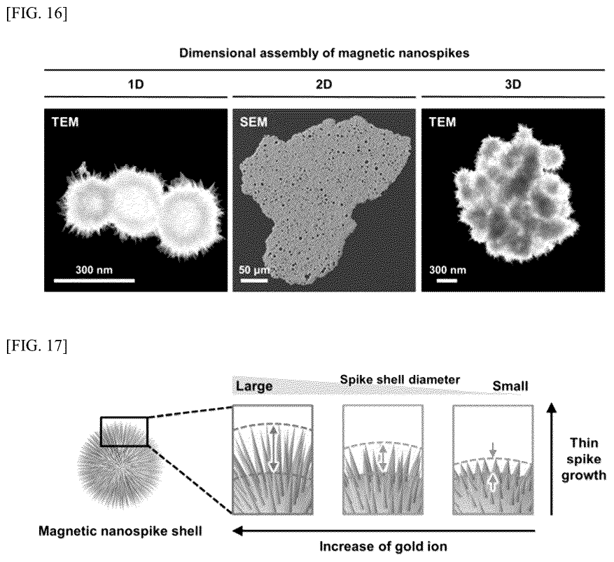

FIG. 16 is a diagram showing transmission electron microscopy (TEM), high-resolution TEM (HR-TEM) images, and selected area diffraction (SAD) analysis of the magnetic structure according to each of Preparing Example 4 to Preparing Example 6. Referring to FIG. 16, in Preparing Example 4 and Preparing Example 5 where the content of Triton-X100 as the surfactant is insufficient, the thickness of the spike structure increases along the (100) crystal plane or the (110) crystal plane of the gold shell, and the twin structure is absent. On the contrary, in the Preparing Example 6, the twin structure is maintained.

The increase in the concentration of the Triton-X100 as the surfactant may increase the interfacial energy between the metal atoms deposited on the surface of the gold shell to promote the anisotropic growth in a form of a spike structure rather than layer-by-layer growth. Accordingly, a thin spike structure in which the diameter of the bottom surface thereof is small is formed.

### Preparing Example 7 to Preparing Example 9 (Control of Thickness of Spike Structure)

FIG. 17 to FIG. 19 are the results of evaluating the magnetic structures according to Preparing Example 7 to Preparing Example 9.

FIG. 17 is a diagram schematically showing change in the thickness of the spike structure based on a content of gold ions in the magnetic structure according to each of Preparing Example 7 to Preparing Example 9. Referring to FIG. 17, as the amount of the gold ions increases, the thicknesses of the spike structures increase approximately uniformly. Accordingly, the spike structure has a predetermined thickness, and the density of the spike structures is higher such that the collection of the spike structures may be formed in a shape similar to a bulk shell.

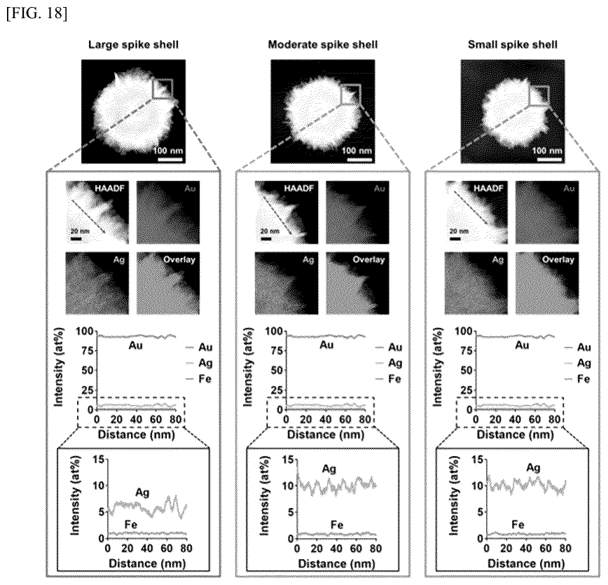

FIG. 18 is a HAADF-STEM and EDS mapping image of the magnetic structure according to each of Preparing Example 7 to Preparing Example 9. In FIG. 18, an EDS line profile showing the intensity of the elements gold (Au), silver (Ag), and iron (Fe) is also included in the elemental overlay image.

Referring to FIG. 18, it may be identified that as the content of HAuCl₄·3H₂O as the source of gold ions decreases, the height of the spike structure decreases. In the process of forming the spike structure, when the ratio of the content of Ag⁺ ions to the content of Au³⁺ ions increases, a larger number of the Ag ions are deposited on the surface of the gold shell. A larger number of reduced Ag atoms acts as a larger number of sites on the surface of the gold shell where the spike structures can grow. Therefore, the spike structures are densely arranged and each spike structure has the increased length. Thus, the spacing between neighboring spike structures is reduced, so that the collection of the spike structures may be formed in a shape similar to a bulk shell.

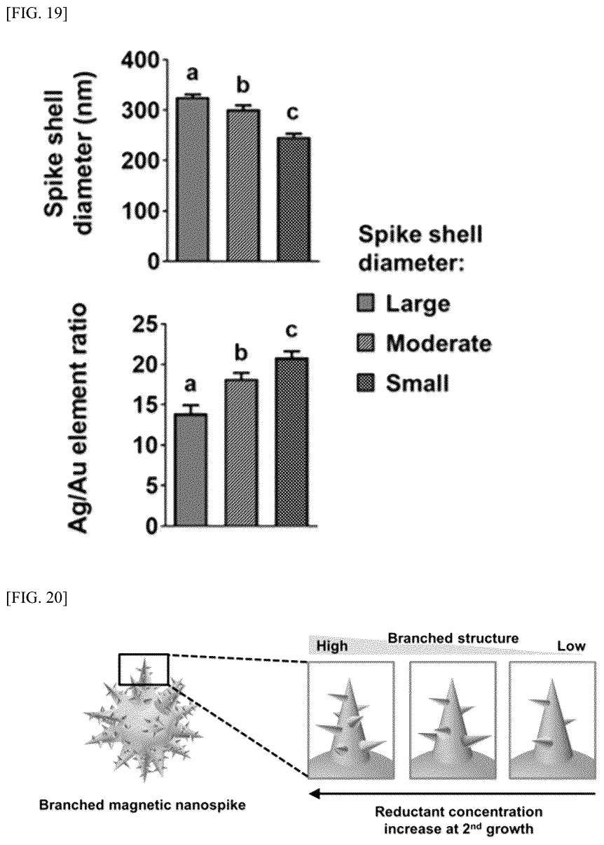

FIG. 19 shows the diameter, the Ag/Au quantification result, and the VSM result of the spike structure of the magnetic structure according to each of Preparing Example 7 to Preparing Example 9. Table 8 shows the results showing the average length of the spike structure of the magnetic structure and the average number of spikes per one magnetic structure according to each of Preparing Example 7 to Preparing Example 9.

TABLE 8

| | | Volume of | Diameter of |
|---|---|---|---|
| | | 5 mM | magnetic |
| Example | Diameter | HAuCl₄•3H₂O | nanospike |
| Preparing | Large | 200 uL | 330 nm |
| Example 7 | | | |
| Preparing | Moderate | 100 uL | 300 nm |
| Example 8 | | | |
| Preparing | Small | 50 uL | 250 |
| Example 9 | | | |

Referring to FIG. 19 and Table 8, as the concentration of the metal ions decreases, that is, as the ratio of the content of the silver ions to the content of the gold ions increases, the diameter of the magnetic nanospike decreases.

### Preparing Example 10 to Preparing Example 12 (Control of Branch Formation on Spike Surface)

FIG. 20 to FIG. 22 are the results of evaluating the magnetic structures according to Preparing Example 10 to Preparing Example 12.

FIG. 20 schematically shows the formation of the branch on the surface of the spike structure in the magnetic structure according to each of Preparing Example 10 to Preparing Example 12. Referring to FIG. 20, the amount of branches formed on the surface of the spike structure may be controlled by controlling the concentration of LAA as the reductant in the process of forming branches. Furthermore, when forming the branches on the spike structure, two steps based seed-mediated growth may be used. The first step seed-mediated growth forms the spike structure on the shell, and the second step seed-mediated growth forms the branches on the surface of the spike structure. Increasing the concentration of the LAA as the reductant in the second step may result in the increase in the density of the branches. When the concentration of the LAA is reduced, the branch density may be reduced.

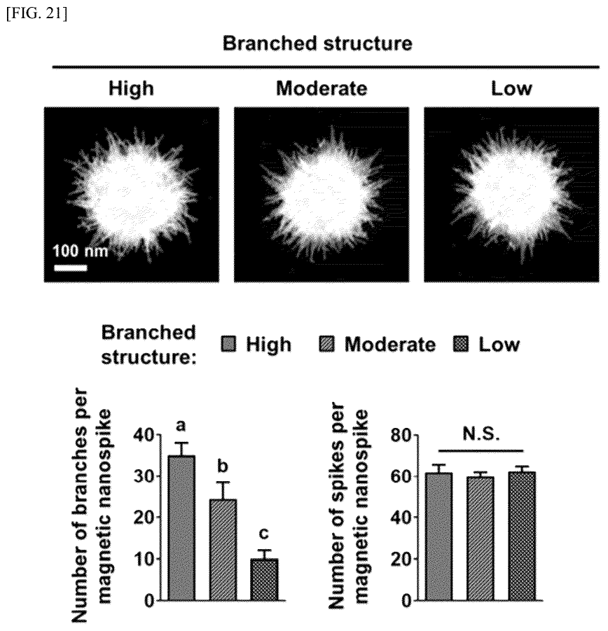

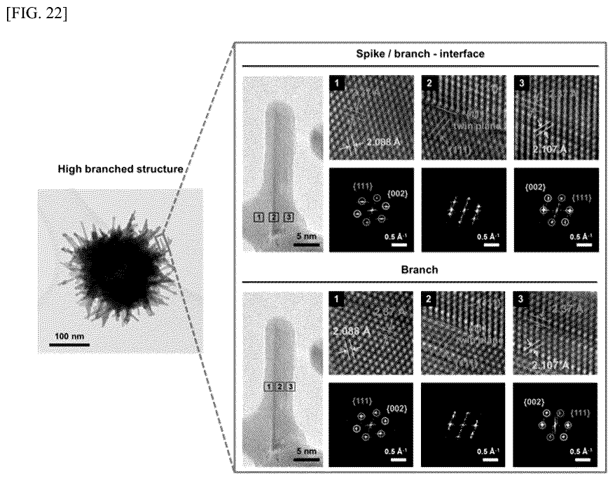

FIG. 21 shows the HAADF-STEM and EDS mapping image and the VSM result of the magnetic structure according to each of Preparing Example 10 to Preparing Example 12. Table 9 shows the results showing the average length of the spike structure of the magnetic structure and the average number of spikes per one magnetic structure according to each of Preparing Example 10 to Preparing Example 12.

TABLE 9

| | | | | | Number of | Number of |
|---|---|---|---|---|---|---|
| | | | Diameter of | Length of | branches per | spikes per |
| | Branch | Concentration of | magnetic | magnetic | magnetic | magnetic |
| Example | density | LAA | nanospike | nanospike | nanospike | structure |
| Preparing | High | 20 mM | 16 nm | 70 nm | 35 | 300 |
| Example 10 | | | | | | |
| Preparing | Moderate | 10 mM | 16 nm | 70 nm | 25 | 300 |
| Example 11 | | | | | | |
| Preparing | Low | 1 mM | 16 nm | 70 nm | 10 | 300 |
| Example 12 | | | | | | |

Referring to FIG. 21 and Table 9, the average diameters of the magnetic nanospike and the densities of the spike structures in Preparing Example 10 to Preparing Example 12 are similar to each other. However, in the case of Preparing Example 10, the largest number of branches are formed on the surface of the spike structure. Thus, it is identified that the number of branches decreases as the concentration of the LAA decreases. That is, after forming the spike structure using the first-step seed-mediated growth, a branch is grown from the spike structure using the second-step seed-mediated growth. The branch grows along the (111) crystal plane of the spike structure.

FIG. 22 is a diagram showing transmission electron microscopy (TEM) and high-resolution TEM (HR-TEM) images, and selected area diffraction (SAD) analysis of the magnetic structure according to Preparing Example 10. Referring to FIG. 22, it is identified that the branch growing from the spike structure grows so as to have a twin structure along the (111) crystal plane of gold.

### Preparing Example 13 (Diameter 50 nm)

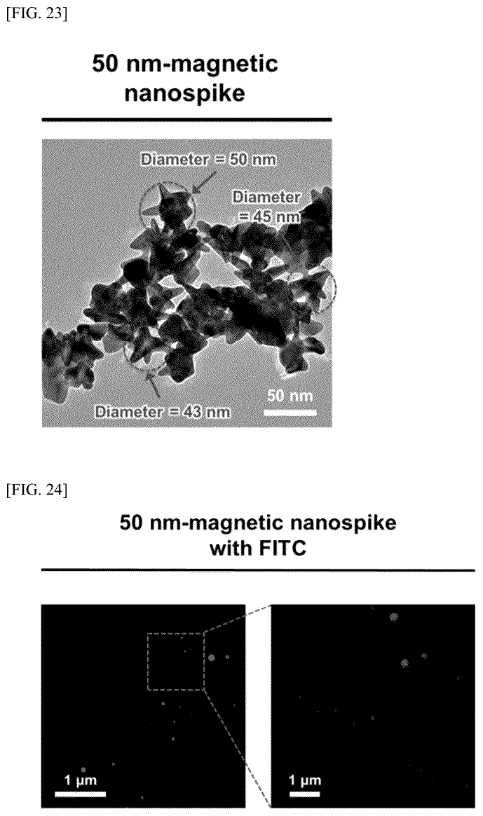

FIG. 23 and FIG. 24 show the results of evaluating the magnetic structure according to Preparing Example 13.

FIG. 23 is a TEM image of a magnetic structure with the average diameter adjusted to 50 nm. FIG. 19 shows high-and low-magnification fluorescence images of a magnetic structure conjugated with FITC (fluorescein isothiocyanate) and having the average diameter adjusted to 50 nm.

Referring to FIG. 23 and FIG. 24, the magnetic structures of the small average diameter, that is, approximately 50 nm may be prepared so as to have a uniform diameter. Furthermore, it is identified that even when the average diameter of the magnetic structure is 50 nm, a spike structure can be formed on the outermost surface thereof. That is, the magnetic structure according to the present embodiment may have the spike structure even when the average diameter of the magnetic structure is 50 nm. Furthermore, as described above, the spike structure may be controlled to have various shapes and sizes.

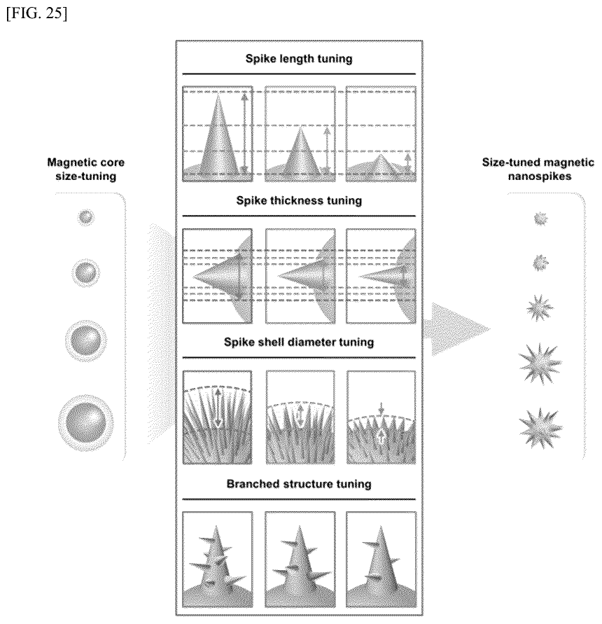

FIG. 25 is a diagram schematically showing the control of the magnetic structure according to the present disclosure. In the magnetic structure with the spike structure according to the present disclosure, all of the length and thickness of the spike structure, the diameter of the shell including the spike structure, and the branch structure may be controlled, and thus magnetic structures with various shapes and sizes may be provided. The magnetic structure may be sequentially composed of the core, the buffer, the shell, and the spike structure (including or excluding the branches).

The core may be composed of one or more nano-sized magnetic nanoparticles. The size of the core may be controlled by controlling the size and number of the magnetic nanoparticles. Furthermore, controlling the size of the core may allow the paramagnetic properties of the magnetic structure to be controlled.

The buffer may attach the shell to the core. The shell may provide the crystal plane on which the spike structure can grow.

The spike structure may be formed in an approximately conical shape with a bottom surface extending from the shell and a height growing from the bottom surface. The spike structure may be formed in various sizes by controlling the dimeter of the bottom surface and the height thereof. Furthermore, the density of the spike structures may be increased, and the density and the size of the branches protruding from the spike structure may be controlled.

Controlling the paramagnetic property, the overall average diameter, and the shape of the spike structure in various ways may allow the magnetic structure according to the present embodiment to be used for various purposes.

A person with ordinary knowledge of the technical field to which the present disclosure belongs will understand that the present disclosure may be implemented in another specific form without changing its technical idea or essential features. Therefore, the embodiments as described above should be understood not as limiting but as illustrative in all respects. The scope of the present disclosure is indicated by the scope of the patent claims as described later rather than the detailed description above, and the meaning and scope of the patent claims and all changes or modified forms derived from the equivalent concept should be interpreted as being included in the scope of the present disclosure.

1. A magnetic structure having a spike structure, the magnetic structure comprising:
a core including at least one magnetic nanoparticle;
a buffer disposed on an outer surface of the core;
a shell disposed on an outer surface of the buffer; and
at least one spike structure protruding outwardly from the shell,
wherein the spike structure is controlled to have various shapes.

2. The magnetic structure of claim 1, wherein the spike structure further includes a plurality of branches protruding from an outer surface of the spike structure,
wherein each of the branches extends from at least a portion of a (111) crystal plane of the outer surface of the spike structure.

3. The magnetic structure of claim 2, wherein the spike structure or the branch includes a nanotwin structure.

4. The magnetic structure of claim 1, wherein an average diameter of a bottom surface of the spike structure is a first length, a height of the spike structure is a second length, and a ratio of the second length to the first length is in a range of 3 to 5,
wherein a cross-sectional shape of the bottom surface of the spike structure is at least one of circular, triangular, square and polygonal shapes.

5. The magnetic structure of claim 4, wherein the first length is in a range of 10 nm to 35 nm, and the second length is in a range of 30 nm to 80 nm.

6. The magnetic structure of claim 1, wherein an average diameter of the magnetic nanoparticle is in a range of 5 nm to 15 nm,
wherein the core has paramagnetic property and an average diameter of the core is in a range of 10 nm to 700 nm,
wherein an average diameter of the magnetic structure is in a range of 50 nm to 800 nm.

7. The magnetic structure of claim 1, wherein the core includes at least one of Fe₃O₄, Fe₂O₃, CoFe₂O₄, MnFe₂O₄, CoPt, and FePt,
wherein the buffer includes at least one of functional-group introduced silica (SiO₂), amine-silica, and thiol-silica,
wherein each of the shell and the spike structure includes gold (Au), silver (Au), or gold-silver (Ag—Au) alloy.

8. The magnetic structure of claim 1, wherein the buffer has an average thickness in a range of 10 nm to 100 nm,
wherein the shell has an average thickness in a range of 10 nm to 20 nm.

9. The magnetic structure of claim 1, wherein the magnetic structure has paramagnetic property,
wherein movement of the magnetic structure is controlled under application of an external magnetic field thereto,
wherein as an average diameter of the core increases, a movement speed of the magnetic structure increases,
wherein a stab movement of a vertex of the spike structure of stabbing a surrounding object is controlled based on the movement speed of the magnetic structure.

10. The magnetic structure of claim 1, wherein the magnetic structure includes a plurality of magnetic structures connected to each other via a first bond or a second bond to form an aggregate.

11. The magnetic structure of claim 10, wherein the first bond includes a magnetic force caused by application of an external magnetic field,
wherein the second bond includes π-π interaction due to the magnetic structure,
wherein the aggregate of the plurality of magnetic structures has at least one of:
a structure in which the plurality of magnetic structures are arranged one-dimensionally and connected to each other via the first bond;
a structure in which the plurality of magnetic structures are arranged in a two-dimensional manner and connected to each other via the first bond or the second bond; and
a structure in which the plurality of magnetic structures are arranged in a three-dimensional manner and connected to each other via the first bond or the second bond.

12. The magnetic structure of claim 1, wherein the shell includes at least one of a (111) crystal plane, a (100) crystal plane, and a (110) crystal plane,
wherein the spike structure has a bottom surface in contact with the shell, and the bottom surface extends from at least a portion of the (111) crystal plane.

13. A method for preparing the magnetic structure having the spike structure according to claim 1, the method comprising:
preparing the core including the at least one magnetic nanoparticle;
coating silica on an outer surface of the core and then introducing a functional-group onto the silica to form the buffer;
forming seeds on an outer surface of the buffer using a seed precursor solution, and forming the shell on the outer surface of the buffer using a shell precursor solution in the seed-mediated growth manner; and
forming at least one spike structure protruding from the shell using a spike precursor solution.

14. The method of claim 13, wherein the spike structure has a bottom surface in contact with the shell and has a cone shape extending in one direction and having a vertex,
wherein an average diameter of the bottom surface of the spike structure is a first length, and a height of the spike structure is a second length,
wherein the shell includes at least one of a (111) crystal plane, a (100) crystal plane, and a (110) crystal plane,
wherein the bottom surface extends from at least a portion of the (111) crystal plane.

15. The method of claim 13, wherein preparing the core includes:
adding and dispersing one or more magnetic nanoparticles to and in a first organic solvent;
adding and mixing a dispersant solution to and with the first organic solvent in which the magnetic nanoparticles have been dispersed, thereby preparing an oil-in-water microemulsion;
removing the first organic solvent from the oil-in-water microemulsion; and
adding and stirring a polymer solution to the oil-in-water microemulsion, thereby preparing the core as a cluster of a plurality of magnetic nanoparticles in which the plurality of magnetic nanoparticles with an average diameter of 50 nm to 700 nm are aggregated with each other.

16. The method of claim 13, wherein forming the buffer includes:
dispersing the cores in the second organic solvent;
adding and mixing ammonia solution or sodium hydroxide aqueous solution to and with the second organic solvent containing the cored dispersed therein, and adding and mixing silica precursor thereto and therewith, thereby coating an outer surface of the core with silica; and
dispersing the silica-coated cores in an alcohol solvent, and adding a functional-group solution thereto and therewith, thereby introducing a functional-group onto the silica.

17. The method of claim 13, wherein the seed precursor solution includes a first basic solution, a first metal aqueous solution, and a seed reductant,
wherein the shell precursor solution includes a second basic solution and a second metal aqueous solution,
wherein forming the shell includes:
dispersing the cores having the buffer formed thereon in a first dispersion solvent to prepare a first mixture;
adding and stirring the first mixture to the seed precursor solution to form seeds on the buffer;
washing the cores having the buffer and the seeds formed thereon at least once and then dispersing the washed cores in a second dispersion solvent, thereby preparing a second mixture;
adding and stirring the second mixture to the shell precursor solution, and then adding a first additive and a second additive thereto, followed by stirring for 0.5 hour to 10 hours; and
after completion of the stirring, isolating a solid material and washing the isolated solid material at least once.

18. The method of claim 13, wherein the spike precursor solution includes a surfactant solution, a third metal aqueous solution, a silver ion compound, a spike reductant, and a functional-group introducing agent,
wherein forming the spike structure includes:
adding and mixing the cores having the buffer and the shell formed thereon, the third metal aqueous solution, and the silver ion compound to a reactor containing therein the surfactant solution; and
adding the spike reductant at a first concentration to the reactor, and performing a reaction at least once for a first time, and then adding the functional-group introducing agent thereto,
wherein a concentration of the silver ion compound is in a range of 1 mM to 20 mM,
wherein a concentration of the surfactant is in a range of 200 mM to 500 mM,
wherein the first concentration of the spike reductant is in a range of 1 mM to 20 mM,
wherein the first time is in a range of 10 minutes to 60 minutes.

19. The method of claim 18, wherein a ratio (Ag⁺/Au³⁺) of a content of silver ions contained in the silver ion compound to a content of metal ions contained in the third metal aqueous solution is in a range of 1 to 4,
wherein as the ratio (Ag⁺/Au³⁺) increases, the first length decreases, whereas when the ratio (Ag⁺/Au³⁺) decreases, the first length increases,
wherein as the concentration of the surfactant solution increases, the first length decreases, whereas when the concentration of the surfactant decreases, the first length increases,
wherein a number of additions of the spike reductant is in a range of 1 to 7 times,
wherein as the number of additions of the spike reductant increases, the second length increases, whereas as the number of additions of the spike reductant decreases, the second length decreases.

20. The method of claim 18, wherein the concentration of the surfactant solution is in a range of 300 mM to 500 mM and the concentration of the spike reductant is in a range of 15 mM to 20 mM,
wherein as a number of additions of the spike reductant increases, the spike structure has a twin structure along the (111) crystal plane, and the second length thereof increases.

21. The method of claim 18, wherein as the concentration of the surfactant solution is lower, the spike structure grows along the (100) crystal plane and the (110) crystal plane, and the first length is in a range of 10 nm to 35 nm, and a twin structure is absent in the spike structure.

22. The method of claim 18, wherein the concentration of the silver ion compound increases, a density of the spike structures and the second length of the spike structure increase, wherein when the concentration of the silver ion compound is 5 mM and a volume thereof is in a range of 20 [symbol] to 200 [symbol] , the first length increases as a concentration of the third metal aqueous solution increases.

23. The method of claim 13, wherein the method further comprises, after forming the spike structure, forming a branch protruding from an outer surface of the spike structure,
wherein the branch is formed using a branch precursor solution,
wherein the branch precursor solution includes a surfactant solution, a fourth metal aqueous solution, a silver ion compound, a branch reductant, and a functional-group introducing agent.
